(19) United States
(12) Patent Application Publication
(10) Pub. No.: US 2024/0040584 A1
(43) Pub. Date: Feb. 1, 2024

(54) UNIFIED TRANSMISSION CONFIGURATION INDICATOR FRAMEWORK FOR PHYSICAL CHANNELS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/258,539

(22) PCT Filed: Jan. 11, 2021
(86) PCT No.: PCT/CN2021/071020

§ 371 Date: Jun. 20, 2023

(51) Int. Cl. H04W 72/232; H04L 5/00

(52) U.S. Cl. CPC H04W 72/232; H04L 5/0048; H04L 5/0091

(57) ABSTRACT

Methods, systems, and devices for wireless communications are described. Generally, a base station may transmit control information to a user equipment (UE) indicating a pair of joint transmission configuration indicator (TCI) states. The UE may use one of the TCI states for receiving or transmitting one or more uplink or downlink messages, and another TCI state for receiving or transmitting a repetition of the one or more messages. In some examples, the base station may transmit separate indications of multiple pairs of TCI states. The UE may use one of the pairs of TCI states for uplink repetitions, and may use another pair of TCI states for downlink repetitions. The UE may indicate the joint or separate TCI states via DCI signaling. In some examples, the UE may update or activate TCI state pairs, and may perform beam forming procedures using the TCI state pair or pairs.

### CROSS REFERENCE

The present application is a 371 national stage filing of International PCT Application No. PCT/CN2021/071020 by YUAN et al. entitled “UNIFIED TRANSMISSION CONFIGURATION INDICATOR FRAMEWORK FOR PHYSICAL CHANNELS,” filed Jan. 11, 2021, which is assigned to the assignee hereof, and which is expressly incorporated by reference in its entirety herein.

### FIELD OF TECHNOLOGY

The following relates to wireless communications, including a unified transmission configuration indicator framework for physical channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support a unified transmission configuration indicator framework for physical channels. Generally, a base station may transmit control information to a user equipment (UE) indicating a pair of joint transmission configuration indicator (TCI) states. In such cases, the UE may use one of the TCI states for receiving or transmitting one or more uplink or downlink messages, and the other TCI state for receiving or transmitting a repetition of the one or more messages. In some examples, the base station may transmit two separate indications of two pairs of TCI states. In such examples, the UE may use one of the pairs of TCI states for uplink repetitions (e.g., physical uplink control channel (PUCCH), physical uplink shared channel (PUSCH) repetitions), and may use the other TCI states for downlink repetitions (physical downlink control channel (PDCCH), physical downlink shared channel (PDSCH) repetitions). The UE may indicate the TCI states, which may include joint or separate TCI states, for example via downlink control information (DCI) signaling, may update or activate one or more TCI state pairs, and may perform beam forming procedures using the one or more TCI state pairs.

A method for wireless communication at a user equipment (UE) is described. The method may include receiving, from a base station, downlink control information including a joint beam indication, the joint beam indication including an indication of a group of transmission configuration indicator states associated with a reference signal, communicating a message on a physical channel using a first transmission configuration indicator state of the group of transmission configuration indicator states, and communicating a repetition of the message on the physical channel using a second transmission configuration indicator state of the group of transmission configuration indicator states.

An apparatus for wireless communication at a UE is described. The apparatus may include a processor, memory in electronic communication with the processor, and instructions stored in the memory. The instructions may be executable by the processor to cause the apparatus to receive, from a base station, downlink control information including a joint beam indication, the joint beam indication including an indication of a group of transmission configuration indicator states associated with a reference signal, communicate a message on a physical channel using a first transmission configuration indicator state of the group of transmission configuration indicator states, and communicate a repetition of the message on the physical channel using a second transmission configuration indicator state of the group of transmission configuration indicator states.

Another apparatus for wireless communication at a UE is described. The apparatus may include means for receiving, from a base station, downlink control information including a joint beam indication, the joint beam indication including an indication of a group of transmission configuration indicator states associated with a reference signal, means for communicating a message on a physical channel using a first transmission configuration indicator state of the group of transmission configuration indicator states, and means for communicating a repetition of the message on the physical channel using a second transmission configuration indicator state of the group of transmission configuration indicator states.

A non-transitory computer-readable medium storing code for wireless communication at a UE is described. The code may include instructions executable by a processor to receive, from a base station, downlink control information including a joint beam indication, the joint beam indication including an indication of a group of transmission configuration indicator states associated with a reference signal, communicate a message on a physical channel using a first transmission configuration indicator state of the group of transmission configuration indicator states, and communicate a repetition of the message on the physical channel using a second transmission configuration indicator state of the group of transmission configuration indicator states.

In some examples of the method, apparatuses, and non-transitory computer-readable medium described herein, communicating the message may include operations, features, means, or instructions for receiving a control message on a physical downlink control channel, receiving a data message on a physical downlink shared channel, or any combination thereof.

Some examples of the method, apparatuses, and non-transitory computer-readable medium described herein may further include operations, features, means, or instructions for determining, based on the reference signal, quasi co-location information associated with the physical downlink control channel, the physical downlink shared channel, or any combination thereof, where receiving the control message, or the data message, or any combination thereof, may be based on the quasi co-location information.

In some examples of the method, apparatuses, and non-transitory computer-readable medium described herein, communicating the message may include operations, features, means, or instructions for transmitting a control message on an physical uplink control channel, transmitting a data message on a physical uplink shared channel, or any combination thereof.

Some examples of the method, apparatuses, and non-transitory computer-readable medium described herein may further include operations, features, means, or instructions for determining, based on the reference signal, a common uplink transmission spatial filter for the control message or the data message, or any combination thereof, where transmitting the control message, or the data message, or any combination thereof, may be based on the common uplink transmission spatial filter.

Some examples of the method, apparatuses, and non-transitory computer-readable medium described herein may further include operations, features, means, or instructions for performing, based on receiving the downlink control information message, a beam sweep procedure using at least the first transmission configuration indicator state and the second transmission configuration indicator state.

Some examples of the method, apparatuses, and non-transitory computer-readable medium described herein may further include operations, features, means, or instructions for comparing a value of a parameter associated with the message with a value of a parameter associated with the repetition of the message and selecting the first transmission configuration indicator state for communicating the message and the second transmission configuration indicator state for communicating the repetition of the message based on the comparing.

In some examples of the method, apparatuses, and non-transitory computer-readable medium described herein, the parameter may include operations, features, means, or instructions for a control resource set pool index, a transmission timing, a reception timing, a frequency resource, a resource set identifier, a resource identifier, a resource block index, a panel identifier, or a transmit receive point identifier, or any combination thereof.

Some examples of the method, apparatuses, and non-transitory computer-readable medium described herein may further include operations, features, means, or instructions for determining a repetition mode for communicating the message and the repetition of the message and communicating the message and the repetition of the message according to the repetition mode.

Some examples of the method, apparatuses, and non-transitory computer-readable medium described herein may further include operations, features, means, or instructions for receiving, from the base station, an indication of the repetition mode, where the determining of the repetition mode may be based on receiving the indication of the repetition mode.

In some examples of the method, apparatuses, and non-transitory computer-readable medium described herein, the repetition mode may include operations, features, means, or instructions for a time division multiplexing mode, a frequency division multiplexing mode, a code division multiplexing mode, a single-frequency network mode, or any combination thereof.

Some examples of the method, apparatuses, and non-transitory computer-readable medium described herein may further include operations, features, means, or instructions for determining that a second physical channel that does not support a repetition mode and communicating a second message on the second physical channel using the first transmission configuration indicator state based on determining that the second physical channel that does not support the repetition mode.

Some examples of the method, apparatuses, and non-transitory computer-readable medium described herein may further include operations, features, means, or instructions for receiving, from the base station, a second downlink control information message activating the group of transmission configuration indicator states from a set of multiple groups of transmission configuration indicator states, where communicating the message using the first transmission configuration indicator state and communicating the repetition of the message using the second transmission configuration indicator state may be based on receiving the second downlink control information message.

Some examples of the method, apparatuses, and non-transitory computer-readable medium described herein may further include operations, features, means, or instructions for receiving, from the base station, a second downlink control information message adding the group of transmission configuration indicator states to a set of multiple groups of transmission configuration indicator states, or removing a second group of transmission configuration indicator states from the set of multiple groups of transmission configuration indicator states, or any combination thereof, where communicating the message using the first transmission configuration indicator state and communicating the repetition of the message using the second transmission configuration indicator state may be based on receiving the second downlink control information message.

In some examples of the method, apparatuses, and non-transitory computer-readable medium described herein, the physical channel may be located on a single component carrier.

In some examples of the method, apparatuses, and non-transitory computer-readable medium described herein, the physical channel may be located on multiple component carriers.

Some examples of the method, apparatuses, and non-transitory computer-readable medium described herein may further include operations, features, means, or instructions for receiving, from the base station, carrier aggregation configuration information for operating in a carrier aggregation mode.

In some examples of the method, apparatuses, and non-transitory computer-readable medium described herein, the downlink control information message includes a downlink UE-specific downlink control information message, an uplink UE-specific downlink control information message, or a group common downlink control information message.

A method for wireless communications at a UE is described. The method may include receiving, from a base station, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, receiving, from the base station using the first group of transmission configuration indicator states, one or more messages on a physical downlink channel, and transmitting, to the base station using the second group of transmission configuration indicator states, one or more messages on an physical uplink channel.

An apparatus for wireless communications at a UE is described. The apparatus may include a processor, memory in electronic communication with the processor, and instructions stored in the memory. The instructions may be executable by the processor to cause the apparatus to receive, from a base station, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, receive, from the base station using the first group of transmission configuration indicator states, one or more messages on a physical downlink channel, and transmit, to the base station using the second group of transmission configuration indicator states, one or more messages on an physical uplink channel.

Another apparatus for wireless communications at a UE is described. The apparatus may include means for receiving, from a base station, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, means for receiving, from the base station using the first group of transmission configuration indicator states, one or more messages on a physical downlink channel, and means for transmitting, to the base station using the second group of transmission configuration indicator states, one or more messages on an physical uplink channel.

A non-transitory computer-readable medium storing code for wireless communications at a UE is described. The code may include instructions executable by a processor to receive, from a base station, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, receive, from the base station using the first group of transmission configuration indicator states, one or more messages on a physical downlink channel, and transmit, to the base station using the second group of transmission configuration indicator states, one or more messages on an physical uplink channel.

In some examples of the method, apparatuses, and non-transitory computer-readable medium described herein, receiving the one or more messages on the physical downlink channel may include operations, features, means, or instructions for receiving a message on the physical downlink channel using a first transmission configuration indicator state of the first group of transmission configuration indicator states and receiving a repetition of the message on the physical downlink channel using a second transmission configuration indicator state of the first group of transmission configuration indicator states.

In some examples of the method, apparatuses, and non-transitory computer-readable medium described herein, the physical downlink channel includes a physical downlink control channel or a physical downlink shared channel.

Some examples of the method, apparatuses, and non-transitory computer-readable medium described herein may further include operations, features, means, or instructions for determining, based on the first reference signal, quasi co-location information associated with the physical downlink control channel, the physical downlink shared channel, or any combination thereof, where receiving the message, the repetition of the message, or both, may be based on the quasi co-location information.

In some examples of the method, apparatuses, and non-transitory computer-readable medium described herein, transmitting the one or more messages on the physical uplink channel may include operations, features, means, or instructions for transmitting a message on the physical uplink channel using a first transmission configuration indicator state of the second group of transmission configuration indicator states and transmitting a repetition of the message on the physical uplink channel using a second transmission configuration indicator state of the second group of transmission configuration indicator states.

In some examples of the method, apparatuses, and non-transitory computer-readable medium described herein, the physical uplink channel includes a physical uplink control channel or a physical uplink shared channel.

Some examples of the method, apparatuses, and non-transitory computer-readable medium described herein may further include operations, features, means, or instructions for determining, based on the second reference signal, a common uplink transmission spatial filter for a control message or a data message, or any combination thereof, where transmitting the message, the repetition of the message, or both, may be based on the common uplink transmission spatial filter.

Some examples of the method, apparatuses, and non-transitory computer-readable medium described herein may further include operations, features, means, or instructions for performing, based on receiving the downlink control information message, a beam sweep procedure using at least the first group of transmission configuration indicator states and the second group of transmission configuration indicator states.

Some examples of the method, apparatuses, and non-transitory computer-readable medium described herein may further include operations, features, means, or instructions for determining a first repetition mode for receiving the one or more messages on the physical downlink channel and a second repetition mode for transmitting the one or more messages on the physical uplink channel, receiving the one or more messages on the physical downlink channel according to the first repetition mode, and transmitting the one or more messages on the physical uplink channel according to the second repetition mode.

Some examples of the method, apparatuses, and non-transitory computer-readable medium described herein may further include operations, features, means, or instructions for receiving, from the base station, an indication of the first repetition mode for a first set of physical channels including the physical downlink channel and receiving, from the base station, an indication of the second repetition mode for a second set of physical channels including the physical uplink channel.

In some examples of the method, apparatuses, and non-transitory computer-readable medium described herein, the first set of physical channels includes a physical downlink control channel and a physical downlink shared channel and the second set of physical channels includes a physical uplink control channel and a physical uplink shared channel.

In some examples of the method, apparatuses, and non-transitory computer-readable medium described herein, the first repetition mode includes a time division multiplexing mode, a frequency division multiplexing mode, a code division multiplexing mode, a single-frequency network mode, or any combination thereof and the second repetition mode includes a time division multiplexing mode, a frequency division multiplexing mode, a code division multiplexing mode, a single-frequency network mode, or any combination thereof.

Some examples of the method, apparatuses, and non-transitory computer-readable medium described herein may further include operations, features, means, or instructions for determining that a second physical downlink channel does not support a repetition mode and receiving, using a first transmission configuration indicator state of the first group of transmission configuration indicator states, one or more messages on the second physical downlink channel based on determining that the second downlink physical channel does not support the repetition mode.

Some examples of the method, apparatuses, and non-transitory computer-readable medium described herein may further include operations, features, means, or instructions for determining that a second physical uplink channel does not support a repetition mode and transmitting, using a first transmission configuration indicator state of the second group of transmission configuration indicator states, one or more messages on the second physical uplink channel based on determining that the second physical uplink channel does not support the repetition mode.

Some examples of the method, apparatuses, and non-transitory computer-readable medium described herein may further include operations, features, means, or instructions for receiving, from the base station, one or more additional downlink control information messages activating the first group of transmission configuration indicator states from a set of multiple groups of transmission configuration indicator states, or the second group of transmission configuration indicator states from a set of multiple groups of transmission configuration indicator states, or both, where receiving the one or more messages on the physical downlink channel using the first group of transmission configuration indicator states and transmitting the one or more messages on the physical uplink channel using the second group of transmission configuration indicator states may be based on receiving the one or more additional downlink control information messages.

Some examples of the method, apparatuses, and non-transitory computer-readable medium described herein may further include operations, features, means, or instructions for receiving, from the base station, one or more additional downlink control information messages adding the first group of transmission configuration indicator states to a set of multiple groups of transmission configuration indicator states, or the second group of transmission configuration indicator states to a set of multiple groups of transmission configuration indicator states, or both, removing a third group of transmission configuration indicator states from the set of multiple groups of transmission configuration indicator states, or any combination thereof, and where receiving the one or more messages on the physical downlink channel using the first group of transmission configuration indicator states and transmitting the one or more messages on the physical uplink channel using the second group of transmission configuration indicator states may be based on receiving the one or more additional downlink control information messages.

In some examples of the method, apparatuses, and non-transitory computer-readable medium described herein, the physical downlink channel may be located on a single component carrier.

In some examples of the method, apparatuses, and non-transitory computer-readable medium described herein, the physical downlink channel may be located on multiple component carriers.

Some examples of the method, apparatuses, and non-transitory computer-readable medium described herein may further include operations, features, means, or instructions for receiving, from the base station, carrier aggregation configuration information for operating in a carrier aggregation mode.

In some examples of the method, apparatuses, and non-transitory computer-readable medium described herein, the physical uplink channel may be located on one component carrier or multiple component carriers.

In some examples of the method, apparatuses, and non-transitory computer-readable medium described herein, the downlink control information message includes a downlink UE-specific downlink control information message, an uplink UE-specific downlink control information message, or a group common downlink control information message.

A method for wireless communications at a base station is described. The method may include transmitting, to a UE, downlink control information including a joint beam indication, the joint beam indication including an indication of a group of transmission configuration indicator states associated with a reference signal, communicating a message on a physical channel using a first transmission configuration indicator state of the group of transmission configuration indicator states, and communicating a repetition of the message on the physical channel using a second transmission configuration indicator state of the group of transmission configuration indicator states.

An apparatus for wireless communications at a base station is described. The apparatus may include a processor, memory in electronic communication with the processor, and instructions stored in the memory. The instructions may be executable by the processor to cause the apparatus to transmit, to a UE, downlink control information including a joint beam indication, the joint beam indication including an indication of a group of transmission configuration indicator states associated with a reference signal, communicate a message on a physical channel using a first transmission configuration indicator state of the group of transmission configuration indicator states, and communicate a repetition of the message on the physical channel using a second transmission configuration indicator state of the group of transmission configuration indicator states.

Another apparatus for wireless communications at a base station is described. The apparatus may include means for transmitting, to a UE, downlink control information including a joint beam indication, the joint beam indication including an indication of a group of transmission configuration indicator states associated with a reference signal, means for communicating a message on a physical channel using a first transmission configuration indicator state of the group of transmission configuration indicator states, and means for communicating a repetition of the message on the physical channel using a second transmission configuration indicator state of the group of transmission configuration indicator states.

A non-transitory computer-readable medium storing code for wireless communications at a base station is described. The code may include instructions executable by a processor to transmit, to a UE, downlink control information including a joint beam indication, the joint beam indication including an indication of a group of transmission configuration indicator states associated with a reference signal, communicate a message on a physical channel using a first transmission configuration indicator state of the group of transmission configuration indicator states, and communicate a repetition of the message on the physical channel using a second transmission configuration indicator state of the group of transmission configuration indicator states.

In some examples of the method, apparatuses, and non-transitory computer-readable medium described herein, communicating the message may include operations, features, means, or instructions for transmitting a control message on a physical downlink control channel, transmitting a data message on a physical downlink shared channel, or any combination thereof.

Some examples of the method, apparatuses, and non-transitory computer-readable medium described herein may further include operations, features, means, or instructions for determining, based on the reference signal, quasi co-location information associated with the physical downlink control channel, the physical downlink shared channel, or any combination thereof, where transmitting the control message, or the data message, or any combination thereof, may be based on the quasi co-location information.

In some examples of the method, apparatuses, and non-transitory computer-readable medium described herein, communicating the message may include operations, features, means, or instructions for receiving a control message on an physical uplink control channel, receiving a data message on a physical uplink shared channel, or any combination thereof.

Some examples of the method, apparatuses, and non-transitory computer-readable medium described herein may further include operations, features, means, or instructions for determining, based on the reference signal, a common uplink transmission spatial filter for the control message or the data message, or any combination thereof, where receiving the control message, or the data message, or any combination thereof, may be based on the common uplink transmission spatial filter.

Some examples of the method, apparatuses, and non-transitory computer-readable medium described herein may further include operations, features, means, or instructions for performing, based on transmitting the downlink control information message, a beam sweep procedure using at least the first transmission configuration indicator state and the second transmission configuration indicator state.

Some examples of the method, apparatuses, and non-transitory computer-readable medium described herein may further include operations, features, means, or instructions for determining a repetition mode for communicating the message and the repetition of the message and communicating the message and the repetition of the message according to the repetition mode.

Some examples of the method, apparatuses, and non-transitory computer-readable medium described herein may further include operations, features, means, or instructions for transmitting, to the UE, an indication of the repetition mode.

In some examples of the method, apparatuses, and non-transitory computer-readable medium described herein, the repetition mode may include operations, features, means, or instructions for a time division multiplexing mode, a frequency division multiplexing mode, a code division multiplexing mode, a single-frequency network mode, or any combination thereof.

Some examples of the method, apparatuses, and non-transitory computer-readable medium described herein may further include operations, features, means, or instructions for determining that a second physical channel that does not support a repetition mode and communicating a second message on the second physical channel using the first transmission configuration indicator state based on determining that the second physical channel that does not support the repetition mode.

Some examples of the method, apparatuses, and non-transitory computer-readable medium described herein may further include operations, features, means, or instructions for transmitting, to the UE, a second downlink control information message activating the group of transmission configuration indicator states from a set of multiple groups of transmission configuration indicator states, where communicating the message using the first transmission configuration indicator state and communicating the repetition of the message using the second transmission configuration indicator state may be based on transmitting the second downlink control information message.

Some examples of the method, apparatuses, and non-transitory computer-readable medium described herein may further include operations, features, means, or instructions for transmitting, to the UE, a second downlink control information message adding the group of transmission configuration indicator states to a set of multiple groups of transmission configuration indicator states, or removing a second group of transmission configuration indicator states from the set of multiple groups of transmission configuration indicator states, or any combination thereof, where communicating the message using the first transmission configuration indicator state and communicating the repetition of the message using the second transmission configuration indicator state may be based on transmitting the second downlink control information message.

In some examples of the method, apparatuses, and non-transitory computer-readable medium described herein, the physical channel may be located on a single component carrier.

In some examples of the method, apparatuses, and non-transitory computer-readable medium described herein, the physical channel may be located on multiple component carriers.

Some examples of the method, apparatuses, and non-transitory computer-readable medium described herein may further include operations, features, means, or instructions for transmitting, to the UE, carrier aggregation configuration information for operating in a carrier aggregation mode.

In some examples of the method, apparatuses, and non-transitory computer-readable medium described herein, the downlink control information message includes a downlink UE-specific downlink control information message, an uplink UE-specific downlink control information message, or a group common downlink control information message.

A method for wireless communications at a base station is described. The method may include transmitting, to a UE, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, transmitting, to the UE using the first group of transmission configuration indicator states, one or more messages on a physical downlink channel, and receiving, from the UE using the second group of transmission configuration indicator states, one or more messages on a physical uplink channel.

An apparatus for wireless communications at a base station is described. The apparatus may include a processor, memory in electronic communication with the processor, and instructions stored in the memory. The instructions may be executable by the processor to cause the apparatus to transmit, to a UE, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, transmit, to the UE using the first group of transmission configuration indicator states, one or more messages on a physical downlink channel, and receive, from the UE using the second group of transmission configuration indicator states, one or more messages on a physical uplink channel.

Another apparatus for wireless communications at a base station is described. The apparatus may include means for transmitting, to a UE, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, means for transmitting, to the UE using the first group of transmission configuration indicator states, one or more messages on a physical downlink channel, and means for receiving, from the UE using the second group of transmission configuration indicator states, one or more messages on a physical uplink channel.

A non-transitory computer-readable medium storing code for wireless communications at a base station is described. The code may include instructions executable by a processor to transmit, to a UE, a downlink control information message including at least one of a first beam indicator and a second beam indicator, the first beam indicator including a first indication of a first group of transmission configuration indicator states associated with a first reference signal and the second beam indicator including a second indication of a second group of transmission configuration indicator states associated with a second reference signal, transmit, to the UE using the first group of transmission configuration indicator states, one or more messages on a physical downlink channel, and receive, from the UE using the second group of transmission configuration indicator states, one or more messages on a physical uplink channel.

In some examples of the method, apparatuses, and non-transitory computer-readable medium described herein, transmitting the one or more messages on the physical downlink channel may include operations, features, means, or instructions for transmitting a message on the physical downlink channel using a first transmission configuration indicator state of the first group of transmission configuration indicator states and transmitting a repetition of the message on the physical downlink channel using a second transmission configuration indicator state of the first group of transmission configuration indicator states.

In some examples of the method, apparatuses, and non-transitory computer-readable medium described herein, the physical downlink channel includes a physical downlink control channel or a physical downlink shared channel.

Some examples of the method, apparatuses, and non-transitory computer-readable medium described herein may further include operations, features, means, or instructions for determining, based on the first reference signal, quasi co-location information associated with the physical downlink control channel, the physical downlink shared channel, or any combination thereof, where transmitting the message, the repetition of the message, or both, may be based on the quasi co-location information.

In some examples of the method, apparatuses, and non-transitory computer-readable medium described herein, transmitting the one or more messages on the physical uplink channel may include operations, features, means, or instructions for receiving a message on the physical uplink channel using a first transmission configuration indicator state of the second group of transmission configuration indicator states and receiving a repetition of the message on the physical uplink channel using a second transmission configuration indicator state of the second group of transmission configuration indicator states.

In some examples of the method, apparatuses, and non-transitory computer-readable medium described herein, the physical uplink channel includes a physical uplink control channel or a physical uplink shared channel.

Some examples of the method, apparatuses, and non-transitory computer-readable medium described herein may further include operations, features, means, or instructions for performing, based on receiving the downlink control information message, a beam sweep procedure using at least the first group of transmission configuration indicator states and the second group of transmission configuration indicator states.

Some examples of the method, apparatuses, and non-transitory computer-readable medium described herein may further include operations, features, means, or instructions for determining a first repetition mode for transmitting the one or more messages on the physical downlink channel and a second repetition mode for receiving the one or more messages on the physical uplink channel, transmitting the one or more messages on the physical downlink channel according to the first repetition mode, and receiving the one or more messages on the physical uplink channel according to the second repetition mode.

Some examples of the method, apparatuses, and non-transitory computer-readable medium described herein may further include operations, features, means, or instructions for transmitting, to the UE, an indication of the first repetition mode for a first set of physical channels including the physical downlink channel and transmitting, to the UE, an indication of the second repetition mode for a second set of physical channels including the physical uplink channel.

In some examples of the method, apparatuses, and non-transitory computer-readable medium described herein, the first set of physical channels includes a physical downlink control channel and a physical downlink shared channel and the second set of physical channels includes a physical uplink control channel and a physical uplink shared channel.

In some examples of the method, apparatuses, and non-transitory computer-readable medium described herein, the first repetition mode includes a time division multiplexing mode, a frequency division multiplexing mode, a code division multiplexing mode, a single-frequency network mode, or any combination thereof and the second repetition mode includes a time division multiplexing mode, a frequency division multiplexing mode, a code division multiplexing mode, a single-frequency network mode, or any combination thereof.

Some examples of the method, apparatuses, and non-transitory computer-readable medium described herein may further include operations, features, means, or instructions for determining that a second physical downlink channel does not support a repetition mode and transmitting, using a first transmission configuration indicator state of the first group of transmission configuration indicator states, one or more messages on the second physical downlink channel based on determining that the second physical downlink channel that does not support the repetition mode.

Some examples of the method, apparatuses, and non-transitory computer-readable medium described herein may further include operations, features, means, or instructions for determining that a second physical uplink channel does not support a repetition mode and receiving, using a first transmission configuration indicator state of the second group of transmission configuration indicator states, one or more messages on the second physical uplink channel based on determining that the second physical uplink channel that does not support the repetition mode.

Some examples of the method, apparatuses, and non-transitory computer-readable medium described herein may further include operations, features, means, or instructions for transmitting, to the UE, one or more additional downlink control information messages activating the first group of transmission configuration indicator states from a set of multiple groups of transmission configuration indicator states, or the second group of transmission configuration indicator states from a set of multiple groups of transmission configuration indicator states, or both, where transmitting the one or more messages on the physical downlink channel using the first group of transmission configuration indicator states and receiving the one or more messages on the physical uplink channel using the second group of transmission configuration indicator states may be based on transmitting the one or more additional downlink control information messages.

Some examples of the method, apparatuses, and non-transitory computer-readable medium described herein may further include operations, features, means, or instructions for transmitting, to the UE, one or more additional downlink control information messages adding the first group of transmission configuration indicator states to a set of multiple groups of transmission configuration indicator states, or the second group of transmission configuration indicator states to a set of multiple groups of transmission configuration indicator states, or both; removing a third group of transmission configuration indicator states from the set of multiple groups of transmission configuration indicator states; removing a third group of transmission configuration indicator states from the set of multiple groups of transmission configuration indicator states; or any combination thereof and where receiving the one or more messages on the physical downlink channel using the first group of transmission configuration indicator states and transmitting the one or more messages on the physical uplink channel using the second group of transmission configuration indicator states may be based on receiving the one or more additional downlink control information messages.

In some examples of the method, apparatuses, and non-transitory computer-readable medium described herein, the physical downlink channel may be located on a single component carrier.

In some examples of the method, apparatuses, and non-transitory computer-readable medium described herein, the physical downlink channel may be located on multiple component carriers.

Some examples of the method, apparatuses, and non-transitory computer-readable medium described herein may further include operations, features, means, or instructions for transmitting, to the UE, carrier aggregation configuration information for operating in a carrier aggregation mode.

In some examples of the method, apparatuses, and non-transitory computer-readable medium described herein, the physical uplink channel may be located on one component carrier or multiple component carriers.

In some examples of the method, apparatuses, and non-transitory computer-readable medium described herein, the downlink control information message includes a downlink UE-specific downlink control information message, an uplink UE-specific downlink control information message, or a group common downlink control information message.

### BRIEF DESCRIPTION OF THE DRAWINGS

FIG. 1 illustrates an example of a wireless communications system that supports a unified transmission configuration indicator framework for physical channels in accordance with aspects of the present disclosure.

FIG. 2 illustrates an example of a repetition scheme that supports a unified transmission configuration indicator framework for physical channels in accordance with aspects of the present disclosure.

FIG. 3 illustrates an example of a process flow that supports a unified transmission configuration indicator framework for physical channels in accordance with aspects of the present disclosure.

FIG. 4 illustrates an example of a process flow that supports a unified transmission configuration indicator framework for physical channels in accordance with aspects of the present disclosure.

FIGS. 5 and 6 show block diagrams of devices that support a unified transmission configuration indicator framework for physical channels in accordance with aspects of the present disclosure.

FIG. 7 shows a block diagram of a communications manager that supports a unified transmission configuration indicator framework for physical channels in accordance with aspects of the present disclosure.

FIG. 8 shows a diagram of a system including a device that supports a unified transmission configuration indicator framework for physical channels in accordance with aspects of the present disclosure.

FIGS. 9 and 10 show block diagrams of devices that support a unified transmission configuration indicator framework for physical channels in accordance with aspects of the present disclosure.

FIG. 11 shows a block diagram of a communications manager that supports a unified transmission configuration indicator framework for physical channels in accordance with aspects of the present disclosure.

FIG. 12 shows a diagram of a system including a device that supports a unified transmission configuration indicator framework for physical channels in accordance with aspects of the present disclosure.

FIGS. 13 through 16 show flowcharts illustrating methods that support a unified transmission configuration indicator framework for physical channels in accordance with aspects of the present disclosure.

### DETAILED DESCRIPTION

Some wireless communications systems may support beam sweeping procedures and repetition on physical channels. In some examples, wireless communications systems may further support joint transmission configuration indicator (TCI) states for downlink and uplink repetition and beam sweeping procedures. A UE may in some examples be configured with a unified TCI state framework (e.g., the UE may be configured with two TCI states associated with a same reference signal). The UE may use the two TCI states for receiving downlink signals. In some examples, the UE may apply a unified TCI state framework to uplink and downlink repetitions (e.g., for receiving control signaling or data signaling, for transmitting control signaling or data signaling). However, UEs may benefit from applying such techniques (e.g., joint or separate TCI state indications for joint TCI states) to uplink or downlink repetitions and beamforming procedures, and other different procedures may not be sufficient to support such unified TCI state frameworks.

In some examples, a base station may transmit control information to a UE indicating a pair of joint TCI states. In such cases, the UE may use one of the TCI states for receiving or transmitting uplink or downlink messages, and the other TCI state for receiving or transmitting a repetition of the messages. In some examples, the base station may transmit two separate indications of two pairs of TCI states. In such examples, the UE may use one of the pairs of TCI states for uplink repetitions (PUCCH or PUSCH repetitions), and may use the other TCI states for downlink repetitions (PDCCH or PDSCH repetitions). The UE may indicate the joint or separate TCI states via DCI signaling. In some examples, the UE may update or activate TCI state pairs for use in a unified TCI state framework. In some examples, the UE may perform beam forming procedures using the TCI state pair or pairs.

Aspects of the disclosure are initially described in the context of wireless communications systems. Aspects of the disclosure are further illustrated by and described with reference to repetition schemes and process flows. Aspects of the disclosure are further illustrated by and described with reference to apparatus diagrams, system diagrams, and flowcharts that relate to a unified transmission configuration indicator framework for physical channels.

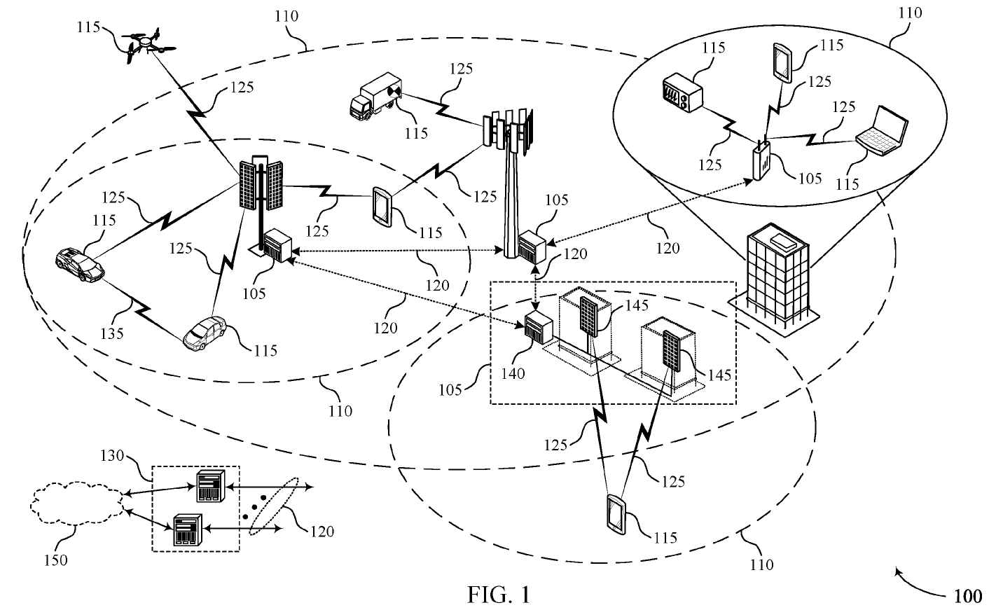

FIG. 1 illustrates an example of a wireless communications system 100 that supports a unified transmission configuration indicator framework for physical channels in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some aspects, a UE 115 of the wireless communications system 100 may be configured with multiple control resource sets (CORESETs) (e.g., up to three CORESETS) within a given BWP. A CORESET may include one or more transmission configuration indicator (TCI) states, for example, for PDCCH repetition, and may be associated with a quantity of resource blocks (RBs) in the frequency domain, or a quantity of symbols or other TTI in the time domain (e.g., quantity of OFDM symbols), or both. In some aspects, a CORESET configured at the UE 115 may be associated with a CCE resource element group (CCE-REG) mapping type (e.g., CCE-REG bundle mapping type), a precoding granularity, an identifier (e.g., scrambling identifier) associated with scrambling for PDCCH demodulation reference signals (DMRS), coded bits of downlink control information (DCI) content, or any combination thereof.

In some aspects, a UE 115 may be configured with up to ten search space sets within a given BWP. In some aspects, each search space set may be associated with a given CORESET, and may include a set of monitoring occasions. In some aspects, a search space set may include a set of control channel monitoring occasions (e.g., PDCCH monitoring occasions). Moreover, a UE 115 may be configured to determine the control channel monitoring occasions associated with a given search space set based on one or more characteristics of the search space set which may be configured (e.g., pre-configured) at the UE 115, indicated to the UE 115 via a base station 105, or both. A UE 115 may be configured with one or more different types of search space sets (e.g., searchSpaceType), including UE-specific search space sets, common search space sets, or both. Additionally, each search space set may be associated with one or more DCI formats which are to be monitored.

Parameters of a search space set (s) may include a periodicity (kₛ) of monitoring occasions (e.g., kₛ slots), an offset (oₛ) for monitoring occasions in units of slots (e.g., oₛ slots) (e.g., monitoringSlotPeriodicityAndOffset), a duration (Tₛ) indicative of a quantity of slots within a period in which the search space set exists (where Tₛ<kₛ), or any combination thereof. A UE 115 of the wireless communications system 100 may determine a quantity of PDCCH monitoring occasions within a slot η_{s,f}^{μ} and a frame η_{f} if η_{f}·Nₛₗₒₜ^{frame,μ}+η_{s,f}^{μ}oₛ mod kₛ=0. In some aspects, when monitoring a control channel, a UE 115 may be configured to monitor control channel candidates (e.g., PDCCH candidates) for a search space set s for Tₛ consecutive slots, starting from slot η_{s,f}^{μ}, and may refrain from monitoring control channel candidates for the search space set s for the next kₛ-Tₛ consecutive slots. Quantities of control channel candidates (e.g., PDCCH candidates) may be based on an aggregation level (e.g., quantity of CCEs) of wireless communications at the UE 115.

In some aspects, a UE 115 may be configured to monitor a control channel according to a control channel monitoring pattern (e.g., PDCCH monitoring pattern) within a slot. For example, a PDCCH monitoring pattern within a slot may indicate a first symbol(s) of a CORESET within a slot for PDCCH monitoring. For instance, in the context of a slot including fourteen symbols, a CORESET configured at a UE 115 may associated with a search space set including three symbols, and a control channel monitoring pattern associated with the search space set may be configured as “01000010001000.” In this example, the UE 115 may be configured to determine three monitoring occasions within each slot of the search space set. Moreover, the UE 115 may be configured to determine that the three monitoring occasions begin at the second, seventh, and eleventh symbols of each respective slot that the search space exists.

In the context of a single-frequency network (SFN), SFN PDCCH transmissions (e.g., PDCCH DMRS) may be associated with two TCI states. In particular, for SFN PDCCH transmissions, one CORESET may be activated at UE 115 with two active TCI states. In such cases, each control channel candidate (e.g., PDCCH candidate) of a search space set associated with the CORESET may be associated with the two active TCI states of the CORESET.

Similarly, for some repetitions (e.g., PDCCH repetitions) in which each PDCCH repetition includes a PDCCH candidate, two PDCCH candidates (e.g., two PDCCH repetitions) may be linked (e.g., related) together for possible repetitions of the same control channel transmission (e.g., repetitions of DCI). In the context of PDCCH repetitions, the payload (e.g., DCI payload) of the two PDCCH candidates (e.g., two PDCCH repetitions) may be the same. For example, a first PDCCH candidate may be related, or linked, to a second PDCCH candidate. In this example, a first repetition of DCI may be transmitted in the first PDCCH candidate, and a second repetition of DCI may be transmitted in the second PDCCH candidate, where the first and second repetitions of DCI are the same. In this example, a UE 115 may receive and/or decode solely the first repetition of DCI or solely the second repetition of DCI. Additionally, or alternatively, the UE 115 may receive and/or decode both the first and second repetitions of DCI by performing soft combining of the first and second repetitions of DCI. In some aspects, related/linked PDCCH candidates may have the same aggregation level (e.g., same quantities of CCEs).

In some aspects, related PDCCH candidates in different search space sets which are associated with corresponding CORESETs may be linked together (e.g., related) for PDCCH repetition. In some cases, two PDCCH candidates with a same candidate index across two related search space sets may be linked (e.g., related). In other cases, PDCCH candidates with a same starting CCE index may be linked. In some aspects, sets of linked PDCCH candidates may be configured via control signaling (e.g., RRC signaling). For example, a UE 115 may receive an RRC message that indicates that a first PDCCH candidate in a first search space set is linked with (e.g., related to) a second PDCCH candidate in a second search space set. Moreover, UEs 115 may be configured with sets of linked PDCCH candidates which are within a same slot or TTI (e.g., intra-slot PDCCH repetition), sets of linked PDCCH candidates which are in different slots (e.g., intra-slot PDCCH repetition), or both.

In some examples, (e.g., for PDCCH reliability with non-SFN schemes), a system may support up to two linked PDCCH candidates. The two PDCCH candidates may be counted towards blind decoding limits and may impact overbooking limitations. In some examples, a UE may down select one or more TCI states from one or more alternatives. Linking options may be based on a fixed rule that may be based on a same PDCCH candidates index, a starting CCE, configurations, or the like. Restrictions or rules may support soft combining of repetitions (e.g., soft combining a transmission of a message with a repetition of the same message, which may be counted as a third PDCCH candidates). In some examples, wireless communications systems may support implicit PUCCH resource determination for a number of PUCCH resources (e.g., more than 8 PUCCH resources) in a resource set, scheduling offsets for a time duration of a QCL relationship, out of order or in order definitions for PDCCH to PDSCH and PDCCH to PUSCH scenarios, DAI for some codebook types (e.g., type-2 Code Books). slot offset values for scheduling a same PDSCH/PUSCH/CS-RS/SRS, rate matching PDSCH around a scheduling DCI, or the like. In some examples, wireless communications supporting signaling repetitions may also support various DCI formats.

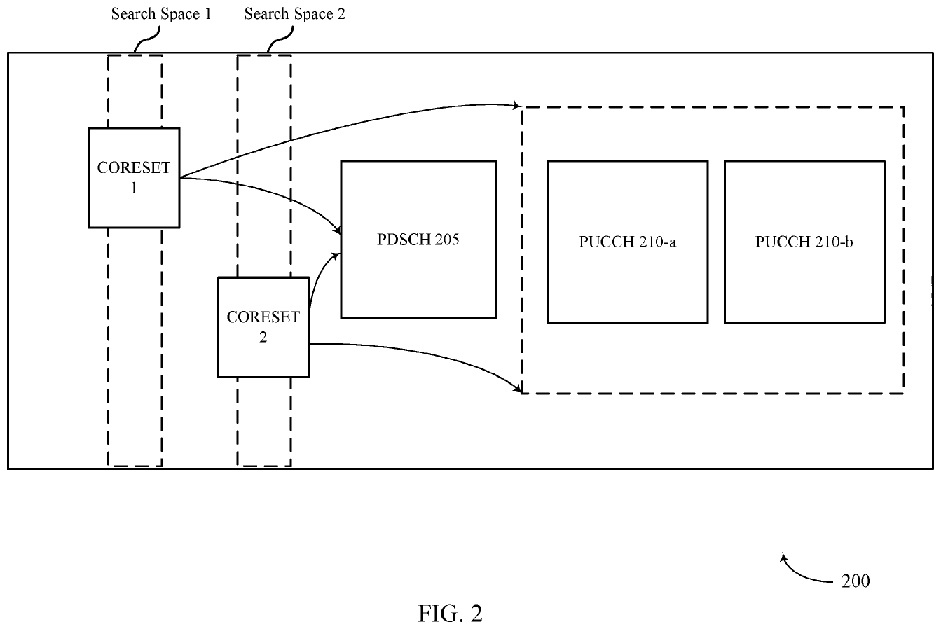

As described in greater detail with reference to FIGS. 2-4, some wireless communications systems may support a beam indication for unified TCI states for downlink and uplink channels. In one example, the unified TCI state may be a joint TCI state, which provides the beam indication to at least one downlink channel and at least one uplink channel. In another example, the unified TCI state may be a separate DL common TCI state, which provides the beam indication to at least two downlink channels. In a further example, the unified TCI state may be a separate UL common TCI state, which provides the beam indication to at least two uplink channels. A unified TCI state as described herein may include at least one reference signal (e.g., a source reference signal) to provide a reference (e.g., a UE assumption) for determining quasi co-location (QCL) relationships, spatial filters, or the like to a target downlink or uplink channel. That is, a UE configured with unified TCI states may determine QCL information or spatial filter information for one or both unified TCI states by relying on one or more reference signals associated with the unified TCI states. For example, an associated reference signal (e.g., a source reference signal) in a number (M) of unified TCI states may provide common QCL information for at least UE-dedicated reception on a physical downlink shared channel (PDSCH) and for all or a subset of CORESETs, or all or a subset of channel state information (CSI) reference signal (RS) resources for CSI acquisition, beam management, tracking, and the like on a particular component carrier (CC). In some example, applicability of unified TCI indications on a PDSCH may include PDSCH default beams. A UE may select between a number of unified TCI states M=1, and N≥1. In another example, source reference signals in a number N of unified TCI states may provide a reference for determining common uplink transmission spatial filters for at least dynamic grant and configured grant based PUSCH, and for all or a subset of dedicated PUCCH resources, or all or a subset of SRS resources in a resource set configured for antenna switching, codebook-based or non-codebook-based uplink transmissions, or the like, on a particular component carrier (CC). In some examples, PUSCH port determination may be based on the unified TCI state (e.g., may be mapped with SRS ports). A UE 115 may select between a number of unified TCI states N=1, and N≥1.

In some examples, beam indication signaling may support multiple beam operations in a unified TCI framework. That is, the base station 105 may provide, to a UE 115, a pair of unified TCI states for use in multiple beam operations, such as beam sweeping or repetitions, or both, to the downlink or uplink channels. The wireless communications system may support layer one (L1)-based beam indications using at least UE-specific (unicast) DCI messages to indicate a pair of unified TCI state from the active unified TCI states. Existing DCI formats 1_1 and 1_2 may be reused or repurposed for beam indications of multiple beam operations. Support mechanisms for UEs 115 to acknowledge successful decoding of beam indications (e.g., ACK/NACK signaling of a PDSCH scheduled by the DCI carrying the beam indication can be used as an ACK also for the DCI. Additional details for supporting unified TCI state frameworks for multiple beam operations are described herein.

In some examples of unified TCI framework, UE 115 may support joint beam indications for uplink and downlink channels in multiple beam operations. For instance, the UE 115 may utilize a pair of joint TCI states for at least one downlink channel in multiple beam operations and at least one uplink channel in multiple beam operations. For example, a source reference signal in the pair of joint TCI states may provide QCL information for UE-dedicated reception on PDSCH, or for UE-dedicated reception on all or a subset of CORESETs in a CC, and may provide a reference for determining common uplink transmission spatial filters for dynamic-grant or configured-grant based PUSCH, for all or a subset of dedicated PUCCH resources, or for all or subset of SRS resources in resource sets in a CC. The SRS resources in resource sets, may be configured for antenna switching, codebook-based uplink transmissions, non-codebook-based uplink transmissions, or any combination thereof.

In some examples of a unified TCI framework, UE 115 may support separate beam indications for uplink or downlink channels. For instance, the UE 115 may utilize two pairs of separate common TCI states, one pair with two separate DL common TCI states for at least two downlink channels in multiple beam operations and another pair with two separate UL common TCI states for at least two uplink channels in multiple beam operations. For separate DL common TCI states, a source reference signal in the pair of TCI states may provide QCL information for UE-dedicated reception on PDSCH, or for UE-dedicated reception on all or a subset of CORESETs in a CC. For separate uplink common TCI states, a source reference signal in the pair of TCI states may provide a reference for determining common uplink transmission spatial filters for dynamic-grant or configured-grant based PUSCH, for all or a subset of dedicated PUCCH resources, or for all or subset of SRS resources in resource sets in a CC, or both. The SRS resources in resource sets, may be configured for antenna switching, codebook-based uplink transmissions, non-codebook-based uplink transmissions, or any combination thereof.

In some examples of a unified TCI state framework, a wireless communications system 100 may support common TCI state identifier updates and activation to provide common QCL information or common uplink transmission spatial filters across a set of configured CCs. Such update and activation procedures may apply to intro-band CA, inter-band CA, joint downlink and uplink, and separate downlink and uplink beam indications. In some examples, common TCI state identifiers may imply that a same or single reference signal identifier determined according to the TCI states indicated by a common TCI state identifier is used to provide QCL information and to determine uplink transmission spatial filters across a set of configured CCs.

In some examples, other different systems may support unified TCI state frameworks for physical uplink and downlink channels without beam sweeping. However, PDSCH and PDCCH repetition with beam sweeping may be supported by wireless communications systems. Other different techniques for unified TCI state frameworks may not be sufficient to support data and control channel repetitions and beam sweeping procedures. Techniques described herein may support application of unified TCI state frameworks to channel repetitions and beam sweeping procedures.

In some examples (e.g., to facilitate signal repetition and beam sweeping using unified TCI state frameworks), a base station 105 may transmit control information to a UE 115 indicating a joint beam indication including a pair of joint TCI states. In such cases, the UE 115 may use one of the joint TCI states for receiving or transmitting uplink and downlink messages, and the other TCI state for receiving or transmitting a repetition of the messages. Base station 105 may provide the joint beam indication for the pair of joint TCI states via DCI signaling.

In some examples, the base station 105 may transmit two separate beam indications respectively including a pair of separate UL common TCI states and a pair of separate DL common TCI states. In such examples, the UE 115 may receive the first separate indication and determine one first pair of separate UL common TCI states for uplink repetitions (PUCCH or PUSCH repetitions), and may receive the second separate indication and determine a second pair of separate DL common TCI states (e.g., the other TCI states) for downlink repetitions (PDCCH or PDSCH repetitions). The base station 105 may provide the separate indications for the pair of separate DL or UL common TCI states via DCI signaling. The two separate indications can be transmitted in the same DCI or two separate DCIs. For example, when the two separate indications are transmitted in the same DCI, the two separate indications may be mapped in the same TCI indication field, and different codepoints of TCI indication field in the DCI may be used to indicate different separate indication. In another example, when the two separate indications are transmitted in the same DCI, the two separate indications may be mapped into two different TCI indication fields in the DCI.

In some examples, base station 105 may update or activate one or more joint TCI states or pairs of separate UL common or DL common TCI states. In some examples, UE 115 may perform beam forming procedures using the joint TCI state pairs or the pairs of separate UL common or DL common TCI states.

FIG. 2 illustrates an example of a repetition scheme 200 that supports a unified transmission configuration indicator framework for physical channels in accordance with aspects of the present disclosure. Repetition scheme 200 may implement or may be implemented by one or more aspects of wireless communications system 100. For example, a UE and a base station may communicate according to repetition scheme 200, and the UE and the base station may be examples of corresponding devices (e.g., UE 115 and base station 105) described with reference to FIG. 1.

Repetition scheme 200 may support uplink or downlink repetitions, beam sweeping, or the like. A wireless communications system may support one or more search spaces (e.g., search space 1 and search space 2). A UE may monitor one or more PDCCH candidates in different CORESETs associated with the search spaces (e.g., CORESET 1 in search space 2, CORESET 2 in search space 2, etc.). In some examples, the base station may transmit a downlink control message (e.g., a DCI message including a downlink grant for PDSCH 205) in CORESET 1. The base station may transmit a repetition of the downlink control message (e.g., the DCI message including an downlink grant for PDSCH 205) in CORESET 2. The UE may monitor the first search space, the second search space, or both, and may receive the DCI message. For instance, the UE may successfully receive the DCI message using CORESET 1, or may successfully receive the DCI message using CORESET 2 (e.g., if the UE fails to receive the DCI message in CORESET 1), or may receive a portion or all of the DCI message using both CORESET 1 and CORESET 2 (e.g., and may perform a soft combining procedure to receive the full DCI message).

Having received the DCI message, the UE may identify one or more resources of PDSCH 205 for receiving downlink signaling. The UE may receive downlink data on PDSCH 205. In some examples, the DCI message may schedule one or more PDSCHs for PDSCH repetition. In such examples, the UE may receive a data message on a first PDSCH 205, and may receive a repetition of the data message on a second PDSCH. In some examples, the UE may soft combine the data message and the repetition of the data message (e.g., the UE may store one or more packets from a partially or completely received data message, and combine the stored one or more data packets with one or more data packets of the repetition of the data message, resulting in a combined set of one or more data packets that may be more reliable than the data message or the repetition of the data message if one or both are partially corrupted).

The UE may transmit a feedback message (e.g., a HARQ ACK or NACK message) indicating whether the UE received the data message on PDSCH 205. The UE may transmit the feedback message on a PUCCH 210. In some examples, the UE may support uplink repetition for the feedback message. In such examples, the UE may transmit the feedback message on PUCCH 210-a, and may transmit a repetition of the feedback message on PUCCH 210-b.

In some examples, as described herein, a wireless communication system may support a unified TCI state framework. For example, the base station may provide a joint beam indication. The joint beam indication may indicate a pair of joint TCI states, where a first TCI state of the pair of joint TCI states is used for transmitting or receiving a message, and a second TCI state of the pair of joint TCI states is used for transmitting or receiving a repetition of the message (e.g., one TCI state for initiate signaling and one TCI state for repetitions). For example, an indicated pair of joint TCI states may be used in downlink signaling (e.g., a first TCI state for CORESET 1 and a second TCI state for CORESET 2). Joint beam indications (e.g., joint TCI state indicators) may efficiently convey multiple TCI states for use in receiving downlink signaling or transmitting uplink signaling, or both.

By leveraging joint beam indication signaling, a UE may identify multiple TCI states without the additional signaling overhead needed for multiple indications of multiple TCI states. Additionally, the UE may utilize the joint TCI state indicator to identify a source reference signal for QCL information, which may increase overall system efficiency, decrease battery expenditures, decrease system latency, etc. However, some unified TCI state frameworks (e.g., legacy unified TCI state frameworks) may not support joint TCI indications for repetitions, beam sweeping procedures, or the like. A wireless communications system that supports unified TCI state frameworks for uplink and downlink repetition, beam sweeping, etc., may more fully leverage the benefits of unified TCI state frameworks while also increasing system efficiency, decreasing the likelihood of failed transmissions (e.g., by using repetitions), improving communication reliability (e.g., via beam sweeping procedures), or the like.

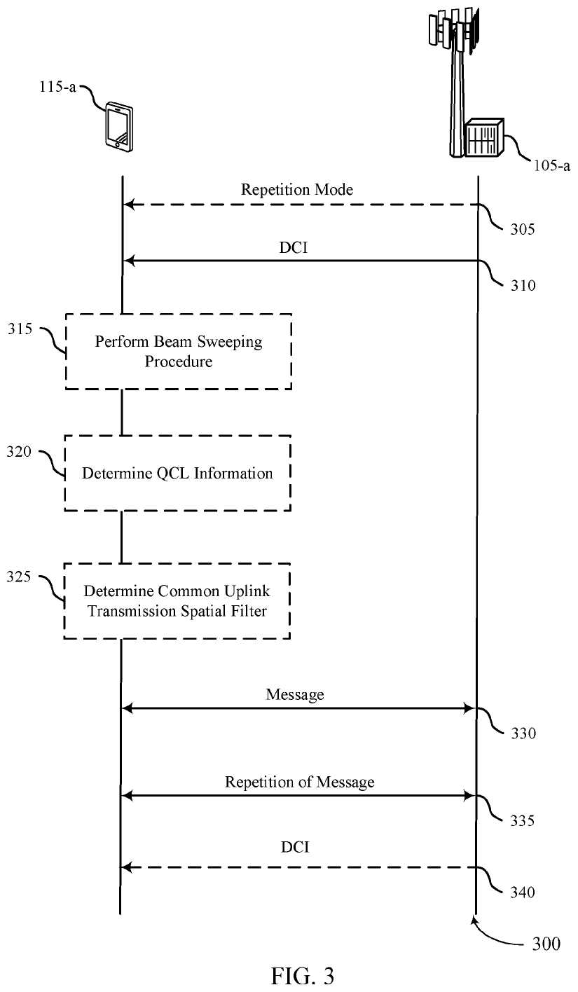

In some examples, as described in greater detail with reference to FIG. 3, a base station may transmit a DCI message including a joint beam indication. The joint beam indication may indicate a pair of joint TCI states for use in uplink and downlink channels. For instance, the UE may use the first TCI state of the pair of joint TCI states to transmit an uplink message (e.g., a control message on a PUCCH or a data message on a PUSCH), and may use the second TCI state of the pair of joint TCI states to transmit a repetition of the uplink message (e.g., on the PUCCH or the PUSCH). Similarly, the UE may use the first TCI state of the pair of TCI states to receive a downlink message (e.g., a control message on a PDCCH or a data message on a PDSCH), and may use the second TCI state of the pair of TCI states to receive a repetition of the downlink message (e.g., on the PDCCH or the PDSCH). For instance, as illustrated with reference to FIG. 2, the UE may receive a DCI message (e.g., via CORESET 1 and CORESET 2), which may trigger data reception on PDSCH 205 and feedback signaling on PUCCH 210. The DCI message may include the joint beam indication, and an indication of PUCCH 210-a and PUCCH 210-b. The UE may transmit a feedback message on PUCCH 210-a using the first TCI state, and may transmit a second feedback message on PUCCH 210-b using the second TCI state. Similarly, if the DCI message includes a grant for uplink repetition on a first PDSCH 205 and a second PDSCH 205, the UE may use the first TCI state to receive the data message on the first PDSCH 205, and may use the second TCI state to receive a repetition of the data message on the second PDSCH 205.

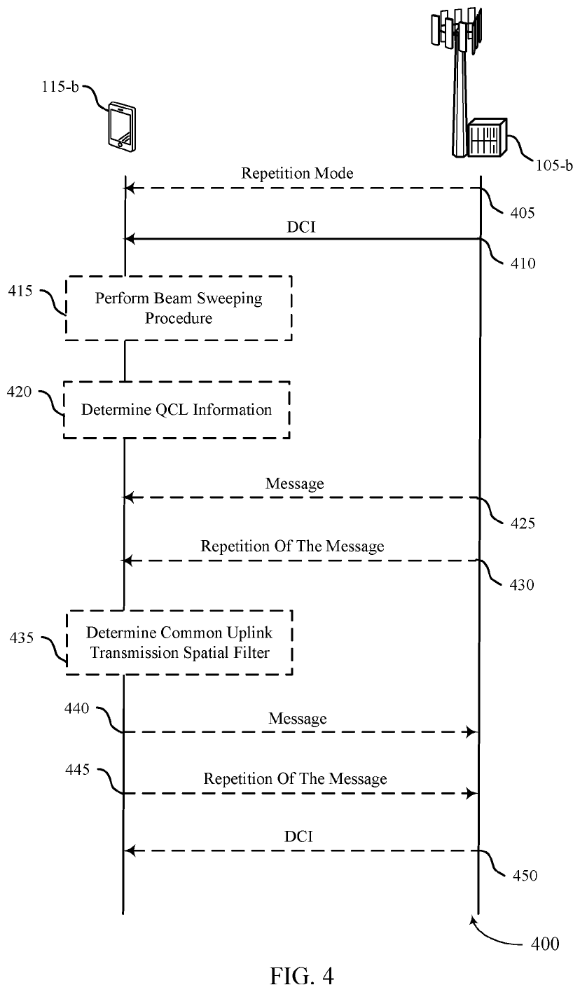

In some examples, as described in greater detail with reference to FIG. 4, the base station may transmit a DCI message including multiple (e.g., two) separate beam indications. Each separate beam indication may indicate a pair of separate downlink or uplink common TCI states. In some examples, the first pair of TCI states may be used for downlink repetition, and the second pair of TCI states may be used for uplink repetition. For instance, the UE may use the first TCI state of the first pair of TCI states to receive a data message on a first PDSCH 205 and may use the second TCI state of the first pair of TCI states to receive a repetition of the data message on a second PDSCH 205. In some examples, the UE may use the first TCI state of the second pair of TCI states to transmit a feedback message on PUCCH 210-a, and may use the second TCI state of the second pair of TCI states to transmit a repetition of the feedback message on PUCCH 210-b.

Each pair of TCI states may be associated with a reference signal (e.g., a source reference signal). The UE may identify spatial filters for uplink transmissions or QCL information for downlink transmissions, or both, based on the associated reference signal. The UE may also use the indicated TCI states for beam forming procedures. Additional details support separate or joint beam indications are described in greater detail herein, including but not limited to reference to FIGS. 3 and 4.

FIG. 3 illustrates an example of a process flow 300 that supports a unified transmission configuration indicator framework for physical channels in accordance with aspects of the present disclosure. Process flow 300 may implement or may be implemented by aspects of wireless communications system 100 and repetition scheme 200. For example, process flow 300 may include a UE 115-a and a base station 105-a, which may be examples of corresponding devices described with reference to FIG. 1 and FIG. 2. In some examples, base station 105-a may provide UE 115-a with a joint beam indication, indicating a pair of TCI states. Both TCI states may be indicated to apply beam sweeping both for downlink and uplink physical channels.

At 310, base station 105-a may transmit, and UE 115-a may receive, a DCI message. The DCI message may include a joint beam indication. The joint beam indication may include an indication of a group (e.g., a pair, more than two) of joint TCI states associated with a reference signal (e.g., a source reference signal). The reference signal in a group of TCI states may provide common QCL information for reception of PDSCH repetition and PDCCH repetition on all or a subset of CORESETs in a CC. UE 115-a may communicate with base station 105-a using the TCI states indicated in the joint beam indication. The reference signal in the group of TCI states may also provide common uplink transmission spatial filter based on the reference signal

In some examples, the wireless communications system may support L1-based beam indications for indicating joint downlink and uplink beam indications with a pair of TCI states from an active TCI state pair for a single serving cell or a group of multiple serving cells in carrier a CA configuration for physical channel transmissions or receptions with repetition. In such examples, the DCI message received at 310 may be a UE-specific (e.g., unicast) downlink DCI (e.g., a DCI format 1_1 or DCI format 1_2 carrying a joint beam indication). In some examples, the DCI message received at 310 may be a group common DCI message (e.g., DCI format 2). In some examples, the DCI message received at 310 may be a UE-specific (e.g., unicast) uplink DCI (e.g., DCI format 0_1 or DCI format 0_2).

At 315, in some examples, UE 115-a may perform one or more beam sweeping procedures using at least one of the group of TCI states (e.g., a first TCI state and a second TCI state of the pair of joint TCI states). For joint beam indications (e.g., or separate beam indications as described in greater detail with reference to FIG. 4), for a single serving cell or a group of multiple serving cells in a CA configuration, UE 115-a may determine if one or more conditions are satisfied, and may perform a beam sweeping procedure based on the satisfied conditions. The conditions may include determining if multiple TCI states are indicated (e.g., via a joint beam indication received at 310). If the DCI message includes an indication of multiple TCI states (e.g., a pair of TCI states, multiple pairs of TCI states, more than two TCI states), then UE 115-a may determine that uplink transmissions or downlink receptions are configured on the physical channels with repetition with a beam sweeping procedure. If solely a single TCI state is indicated, then UE 115-a may determine that physical channel transmissions or receptions applicable with the indication are indicated without an instruction to perform a beam sweeping procedure.

In some examples, UE 115-a may communicate (e.g., receive) one or more downlink messages with base station 105-a. For instance, at 320, UE 115-a may determine QCL information for downlink data messages on a PDSCH, or control messages on a PDCCH, or both. UE 115-a may determine the QCL information based on the reference signal (e.g., that is associated with the group of joint TCI states) indicated by the DCI received at 310. UE 115-a may use the QCL information to prepare (e.g., adjust one or more antennas, antenna ports, or the like) for receiving downlink signaling using the TCI states of the joint beam indication. At 330, UE 115-a may receive a data message on the PDSCH or a control message on the PDCCH, or both, using the first TCI state of the group of joint TCI states. At 335, UE 115-a may receive a repetition of the downlink control message or the downlink data message using the second TCI state of the group of joint TCI states.

In the case of downlink signaling at 330 and 335, among other examples, the PDSCH and the PDCCH may be UE dedicated physical channels. For example, at least one of the PDSCH and the PDCCH may be allocated for downlink transmissions to UE 115-a. In some examples, UE 115-a may select one of the TCI states of the group of joint TCI states to be a first TCI state (e.g., for messages) and may select a second TCI state of the group of TCI states to be a second TCI state (e.g., for repetitions). UE 115-a may, in some examples, select the TCI states by comparing a value of a parameter associated with the message with a parameter associated with the repetition of the message. For instance, UE 115-a may apply a first TCI state (or a second TCI state) to the PDSCH reception with the lowest CORESET pool index, the earliest set of time occasions, the lower part of the frequency resource allocations, or the like. Similarly, UE 115-a may apply a first TCI state (or a second TCI state) to the PDCCH repetition with the lower CORESET pool index, the lower CORESET identifier, the lower search space ID, earlier PDCCH monitoring occasion, PDCCH starting or ending symbol, lower PDCCH resource block or resource element index, smaller PDCCH candidate index, starting CCE index, lower panel identifier, lower transmit receive point (TRP) identifier, or any combination thereof.

In some examples, UE 115-a may communicate one or more uplink messages with base station 105-a. For instance, at 325, UE 115-a may determine a common uplink transmission spatial filter for a control message, a data message, or both. The UE may determine the common uplink transmission spatial filter based on the reference signal (e.g., that is associated with the group of TCI states) indicated by the DCI received at 310. UE 115-a may use the common uplink transmission spatial filter to prepare (e.g., adjust one or more antennas, or antenna ports, or the like), for transmitting uplink signaling using the joint TCI states of the joint beam indication. At 330, UE 115-a may transmit a data message on a PUSCH or a control message on a PUCCH, or both, using the first TCI state of the group of joint TCI states. At 335, UE 115-a may transmit a repetition of the uplink control message or the uplink data message using the second TCI state of the group of joint TCI states.

In the case of uplink signaling at 330 and 335, the PUSCH and the PUCCH may be UE dedicated physical channels. For example, at least one of the PUSCH and the PUCCH may be allocated for uplink transmissions by UE 115-a. In some examples, UE 115-a may select one of the TCI states of the group of joint TCI states to be a first TCI state (e.g., for messages) and a second TCI state of the group of joint TCI states to be a second TCI state (e.g., for repetitions). UE 115-a may select the TCI states by comparing a value of a parameter associated with the message with a parameter associated with the repetition of the message. For instance, UE 115-a may apply a first TCI state (or a second TCI state) to a PUSCH repetition with a lower CORESET pool index, earlier set of time occasions, lower part of frequency resource allocations, or the like. UE 115-a may apply a first TCI state (or a second TCI state) to a PUCCH repetition with a lower CORESET pool index, a lower resource set identifier, a lower resource identifier, a lower PUCCH resource block or resource element index, a lower panel identifier, a lower TRP identifier, or the like.

In some examples, UE 115-a may communicate the message and the repetition of the message (e.g., the uplink control or data message, or the downlink control or data message) at 330 and 335 according to a repetition mode. The repetition mode may be a time-division multiplexing (TDM) mode, a frequency division multiplexing (FDM) mode, a code division multiplexing mode (CDM), a single-frequency network (SFN) mode, or the like. In some examples, base station 105-a may transmit an indication of the repetition mode (e.g., for a PDCCH, a PDSCH, a PUSCH, or a PUCCH) at 305. Base station 105-a may transmit the indication of the repetition mode via common signaling to or for all downlink and uplink channels (e.g., a single repetition mode for all physical channels). In some examples, base station 105-a may transmit separate indications different subsets of physical channels. For instance, base station 105-a may transmit an indication of a repetition mode (e.g., an SFN mode) for a PDCCH and PDSCH, and another, separate indication of a repetition mode (e.g., a TDM repetition mode) for a PUSCH and a PUCCH. In some examples, an indication of the repetition mode may be included in the DCI received at 310.

In some examples, when supporting joint beam indications for physical uplink and downlink channels with repetitions, base station 105-a may configure a subset of channels with no repetition. In such examples, for the subset of channels configured with no repetition, UE 115-a may ignore the second TCI state of the group (e.g., pair) of joint TCI states, and may use the first TCI state of the group of joint TCI states for communications on the subset of channels. When communicating on remaining physical channels that support repetition, UE 115-a may use both TCI states in the pair of joint TCI states for repetitions, as described at 330 and 335.

In some examples, a wireless communications system may support TCI state identifiers or TCI state pair identifier updating and activation procedures to provide a pair of common QCL information or common uplink transmission spatial filters for physical channel repetitions across a set of configured CCs. For example, base station 105-a may transmit a DCI message at 340. The DCI message may include an indication of a new joint beam indication (e.g., indicating a second group of joint TCI states), an instruction to remove one or more TCI states or groups of joint TCI states from a list of configured TCI states or groups of joint TCI states, or the like. In some examples, each joint beam indication or group of joint TCI states may be associated with a group TCI state identifier. The DCI received at 340 may include a list of group TCI state identifiers to be added to a list of configured groups of joint TCI states, a list of group TCI state identifiers to be removed from the list of configured groups of joint TCI states, or both. In some examples, the DCI message received at 340 may include an instruction to activate or deactivate one or more groups of joint TCI states. For instance, base station 105-a may previously configure a list of candidate groups of joint TCI states. The DCI message received at 310 may indicate a first group of joint TCI states from the list of candidate groups of joint TCI states. The DCI message received at 340 may deactivate the previously indicated group of joint TCI states, may activate a second group of joint TCI states, or both. In some examples, an identifier for a common TCI state or a pair of TCI states may imply that a same pair of reference signals determined according to the pair of TCI states indicated by a common TCI state identifier or a pair of common TCI state identifier are used to provide a pair of QCL type-D indications, to determine a pair of uplink transmission spatial filters, or both, across a set of configured CCs. Activation or updating of TCI states, pairs of joint TCI states, groups of joint TCI states or the like, may be supported for intra-band CA and inter-band CA, joint downlink and uplink indicators, or separate downlink and uplink beam indications.

In some examples, base station 105-a may configure separate groups of TCI states for uplink signaling and downlink signaling, as described in greater detail with reference to FIG. 4.

FIG. 4 illustrates an example of a process flow 400 that supports a unified transmission configuration indicator framework for physical channels in accordance with aspects of the present disclosure. Process flow 400 may implement aspects of wireless communications system 100, repetition scheme 200, and process flow 300. For example, process flow 400 may include a UE 115-b and a base station 105-b, which may be examples of corresponding devices described with reference to FIG. 1, FIG. 2, and FIG. 3. In some examples, base station 105-b may provide UE 115-b with separate beam indications (e.g., a first beam indication and a second beam indication), indicating multiple groups (e.g., pairs) of separate common TCI states. One group (e.g., pair) of TCI states may be indicated for downlink physical channel repetition, and one group (e.g., pair) of TCI states may be indicated for uplink physical channel repetition.

At 410, base station 105-b may transmit, and UE 115-b may receive, a DCI message. The DCI message may include at least one of a first beam indication and a second beam indication. The first beam indication may include an indication of a first group (e.g., pair) of common TCI states associated with a first reference signal (e.g., a source reference signal), and the second beam indication may include an indication of a second group (e.g., pair) of common TCI states associated with a second reference signal. The reference signal in a given group of TCI states may provide common QCL information for reception of PDSCH repetition and PDCCH repetition on all or a subset of CORESETs in a CC. UE 115-b may communicate with base station 105-b using the TCI states indicated in the joint beam indication. The two separate indications can be transmitted in the same DCI or two separate DCIs. For example, when the two separate indications are transmitted in the same DCI, the two separate indications may be mapped in the same TCI indication field, and different codepoints of TCI indication field in the DCI may be used to indicate different separate indication. In another example, when the two separate indications are transmitted in the same DCI, the two separate indications may be mapped into two different TCI indication fields in the DCI. In some examples, base station 105-b may transmit a first beam indication for the first group of TCI states in a first DCI message, and a second beam indication for the second group of TCI states in a second DCI message.

In some examples, the wireless communications system may support L1-based beam indications for indicating separate downlink and uplink beam indications with a pair of TCI states from an active TCI state pair for a single serving cell or a group of multiple serving cells in carrier a CA configuration for physical channel transmissions or receptions with repetition. In such examples, the DCI message received at 310 may be a UE-specific (e.g., unicast) downlink DCI (e.g., a DCI format 1_1 or DCI format 1_2 carrying a joint beam indication). In some examples, the DCI message received at 310 may be a group common DCI message (e.g., DCI format 2). In some examples, the DCI message received at 310 may be a UE-specific (e.g., unicast) uplink DCI (e.g., DCI format 0_1 or DCI format 0_2).

At 415, in some examples, UE 115-b may perform one or more beam sweeping procedures using at least one of the separate groups of TCI states (e.g., a first TCI state or a second TCI state of the first separate pair of TCI states, a first TCI state or a second TCI state of the second pair of separate TCI states, or any combination thereof). For beam indications, for a single serving cell or a group of multiple serving cells in a CA configuration, UE 115-b may determine if one or more conditions are satisfied, and may perform a beam sweeping procedure based on the satisfied conditions. The conditions may include determining if multiple TCI states are indicated (e.g., via separate beam indication received at 410). If the DCI message includes an indication of multiple TCI states (e.g., a pair of TCI states, or multiple separate pairs of TCI states), then UE 115-b may determine that uplink transmissions or downlink receptions are configured on the physical channels with repetition with a beam sweeping procedure. If solely a single TCI state is indicated, then UE 115-b may determine that physical channel transmissions or receptions applicable with the indication are indicated without an instruction to perform a beam sweeping procedure.

In some examples, UE 115-b may receive one or more downlink messages from base station 105-b. For instance, at 420, UE 115-b may determine QCL information for downlink data messages on a PDSCH, or control messages on a PDCCH, or both. UE 115-b may determine the QCL information based on the reference signal (e.g., that is associated with a group of TCI states) indicated by the DCI received at 410. UE 115-b may use the QCL information to prepare (e.g., adjust one or more antennas, antenna ports, or the like), for receiving downlink signaling using the separate TCI states of the separate beam indications. At 425, UE 115-b may receive a data message on the PDSCH or a control message on the PDCCH, or both, using the first TCI state of the first group of separate (downlink common) TCI states. At 430, UE 115-b may receive a repetition of the downlink control message or the downlink data message using the second TCI state of the first group of separate (e.g., downlink common) TCI states.

In the case of downlink signaling at 425 and 430, the PDSCH and the PDCCH may be UE dedicated physical channels. For example, at least one of the PDSCH and the PDCCH may be allocated for downlink transmissions to UE 115-a. The source reference signal in each pair of TCI states may provide common QCL information for reception of the PDSCH repetitions and PDCCH repetitions on all or a subset of CORESETs in a CC.

In some examples, UE 115-b may transmit one or more uplink messages to base station 105-b. For instance, at 435, UE 115-b may determine a common uplink transmission spatial filter for a control message, a data message, or both. UE 115-b may determine the common uplink transmission spatial filter based on the reference signal (e.g., that is associated with the group of TCI states) indicated by the DCI received at 410. The reference signal (e.g., the common reference signal) in each pair of common TCI states indicated at 410 may provide a reference for determining common uplink transmission spatial filters for transmitting PUSCH repetitions, and all or a subset of PUCCH repetitions in a CC. UE 115-b may use the common uplink transmission spatial filter to prepare (e.g., adjust one or more antennas, or antenna ports, or the like), for transmitting uplink signaling using the TCI states of the second group of separate TCI states. At 440, UE 115-b may transmit a data message on a PUSCH or a control message on a PUCCH, or both, using the first TCI state of the second group of separate (e.g., common uplink) TCI states. AT 445, UE 115-b may transmit a repetition of the uplink control message or the uplink data message using the second TCI state of the second group of separate (e.g., common uplink) TCI states. In the case of uplink signaling at 440 and 445, the PUSCH, the PUCCH, or both may be UE dedicated physical channels.

In some examples, UE 115-b may transmit or receive a message and the repetitions of the message (e.g., the uplink control or data message at 440 and 445, or the downlink control or data message at 425 and 430) according to a repetition mode. The repetition mode may be a TDM mode, an FDM mode, a CDM, an SFN mode, or the like. In some examples, base station 105-b may transmit an indication of the repetition mode (e.g., for a PDCCH, a PDSCH, a PUSCH, or a PUCCH) at 405. Base station 105-b may transmit separate indications different subsets of physical channels. For instance, base station 105-b may transmit an indication of a repetition mode for a PDCCH and PDSCH, and another, separate repetition mode for a PUSCH and a PUCCH. In some examples, an indication of the repetition mode may be included in the DCI received at 410.

In some examples, when supporting separate uplink and downlink beam indications for physical channels with repetitions, base station 105-b may configure a subset of channels with no repetition. In such examples, for the subset of channels configured with no repetition, UE 115-b may ignore the second TCI state of each group (e.g., pair) of TCI states, and may use the first TCI state of each group of TCI states for communications on the subset of channels (e.g., the first TCI state of the first group of TCI states for PDCCH and PDSCH, and the first TCI state of the second group of TCI states for PUSCH and PUCCH). When communicating on remaining physical channels that support repetition, UE 115-b may use both TCI states in each group of common TCI states for repetitions.

In some examples, a wireless communications system may support TCI state or TCI state pair identifier updating and activation procedures to provide a pair of common QCL information or common uplink transmission spatial filters for physical channel repetitions across a set of configured CCs. For example, base station 105-b may transmit a DCI message at 450. The DCI message may include an indication of one or more new beam indications (e.g., indicating a third group of separate TCI states), an instruction to remove one or more TCI states or groups of separate TCI states from a list of configured TCI states or groups of separate TCI states, or the like. In some examples, each beam indication or group of separate TCI states may be associated with a group TCI state identifier. The DCI received at 450 may include a list of group TCI state identifiers to be added to a list of configured groups of separate TCI states, a list of group TCI state identifiers to be removed from the list of configured groups of TCI states, or both. In some examples, the DCI message received at 450 may include an instruction to activate or deactivate one or more groups of TCI states. For instance, base station 105-b may previously configure a list of candidate groups of separate TCI states. The DCI message received at 410 may indicate a first group of TCI states and a second group of TCI states from the list of candidate groups of TCI states. The DCI message received at 450 may deactivate one or both of the previously indicated groups of TCI states, may activate one or more additional groups of TCI states, or both. In some examples, an identifier for a common TCI state or a pair of separate TCI states may imply that a same pair of reference signals determined according to the pair of separate TCI states indicated by a common TCI state identifier or a pair of common TCI state identifier are used to provide a pair of QCL type-D indications, to determine a pair of uplink transmission spatial filters, or both, across a set of configured CCs. Activation or updating of TCI states, pairs of separate TCI states, groups of TCI states or the like, may be supported for intra-band CA and inter-band CA, joint downlink and uplink indicators, or separate downlink and uplink beam indications.

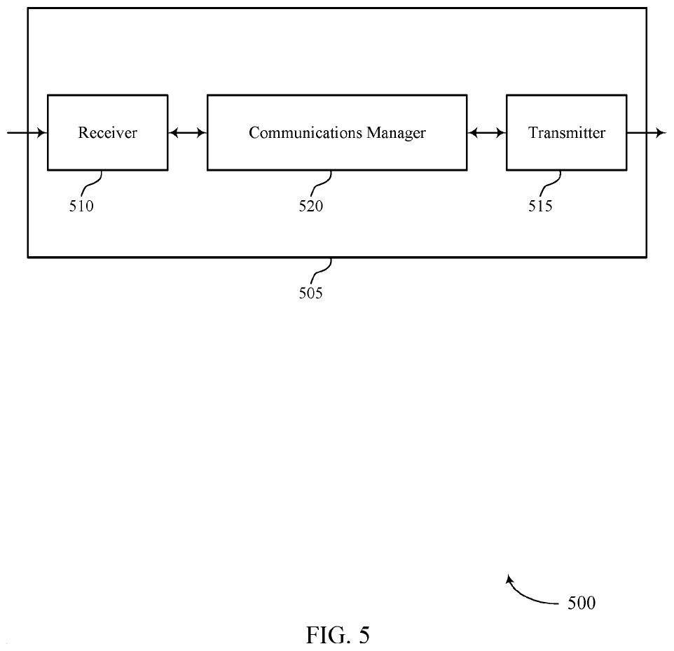

FIG. 5 shows a block diagram 500 of a device 505 that supports a unified transmission configuration indicator framework for physical channels in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to a unified transmission configuration indicator framework for physical channels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to a unified transmission configuration indicator framework for physical channels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of a unified transmission configuration indicator framework for physical channels as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving, from a base station, downlink control information including a joint beam indication, the joint beam indication including an indication of a group of transmission configuration indicator states associated with a reference signal. The communications manager 520 may be configured as or otherwise support a means for communicating a message on a physical channel using a first transmission configuration indicator state of the group of transmission configuration indicator states. The communications manager 520 may be configured as or otherwise support a means for communicating a repetition of the message on the physical channel using a second transmission configuration indicator state of the group of transmission configuration indicator states.

Additionally, or alternatively, the communications manager 520 may support wireless communications at a UE in accordance with examples as disclosed herein. For example, the communications manager 520 may be configured as or otherwise support a means for receiving, from a base station, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The communications manager 520 may be configured as or otherwise support a means for receiving, from the base station using the first group of transmission configuration indicator states, one or more messages on a physical downlink channel. The communications manager 520 may be configured as or otherwise support a means for transmitting, to the base station using the second group of transmission configuration indicator states, one or more messages on a physical uplink channel.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for unified TCI frameworks such that a UE may more efficiently make use of available system resources, more efficiently use computational resources, reduce signaling overhead, reduce system congestion, and improve user experience.

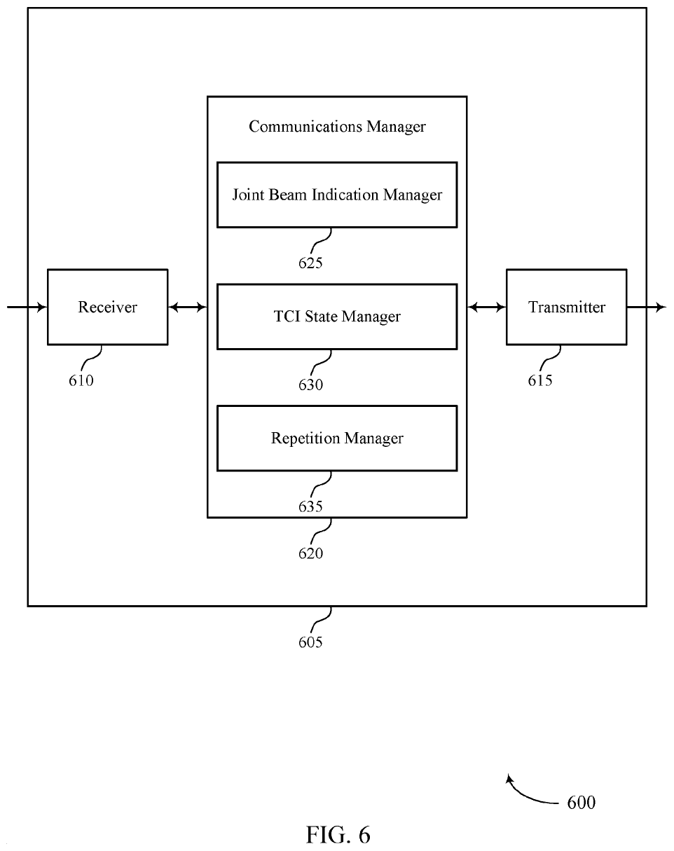

FIG. 6 shows a block diagram 600 of a device 605 that supports a unified transmission configuration indicator framework for physical channels in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to a unified transmission configuration indicator framework for physical channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to a unified transmission configuration indicator framework for physical channels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of a unified transmission configuration indicator framework for physical channels as described herein. For example, the communications manager 620 may include a joint beam indication manager 625, a TCI state manager 630, a repetition manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The joint beam indication manager 625 may be configured as or otherwise support a means for receiving, from a base station, downlink control information including a joint beam indication, the joint beam indication including an indication of a group of transmission configuration indicator states associated with a reference signal. The TCI state manager 630 may be configured as or otherwise support a means for communicating a message on a physical channel using a first transmission configuration indicator state of the group of transmission configuration indicator states. The repetition manager 635 may be configured as or otherwise support a means for communicating a repetition of the message on the physical channel using a second transmission configuration indicator state of the group of transmission configuration indicator states.

Additionally, or alternatively, the communications manager 620 may support wireless communications at a UE in accordance with examples as disclosed herein. The joint beam indication manager 625 may be configured as or otherwise support a means for receiving, from a base station, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The TCI state manager 630 may be configured as or otherwise support a means for receiving, from the base station using the first group of transmission configuration indicator states, one or more messages on a physical downlink channel. The TCI state manager 630 may be configured as or otherwise support a means for transmitting, to the base station using the second group of transmission configuration indicator states, one or more messages on a physical uplink channel.

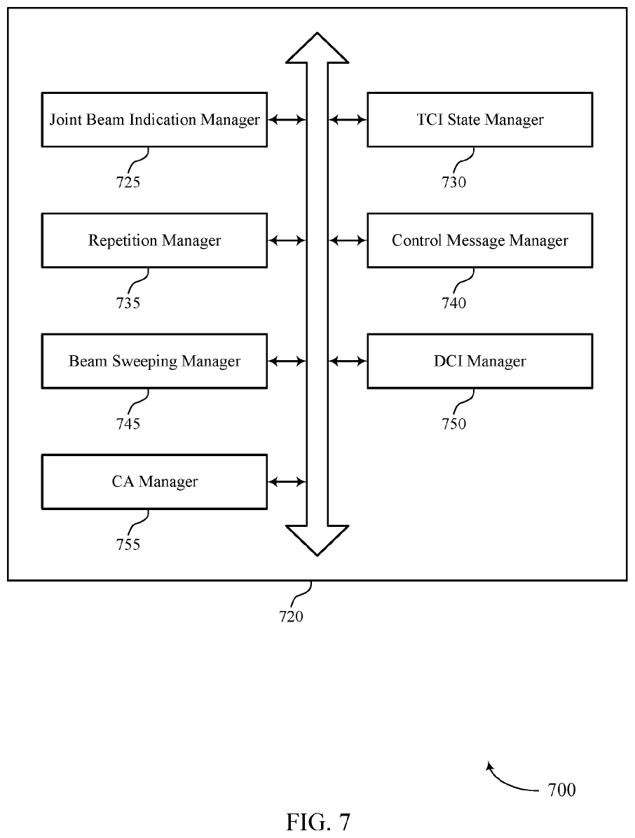

FIG. 7 shows a block diagram 700 of a communications manager 720 that supports a unified transmission configuration indicator framework for physical channels in accordance with aspects of the present disclosure. The communications manager 720 may be an example of aspects of a communications manager 520, a communications manager 620, or both, as described herein. The communications manager 720, or various components thereof, may be an example of means for performing various aspects of a unified transmission configuration indicator framework for physical channels as described herein. For example, the communications manager 720 may include a joint beam indication manager 725, a TCI state manager 730, a repetition manager 735, a control message manager 740, a beam sweeping manager 745, a DCI manager 750, a CA manager 755, or any combination thereof. Each of these components may communicate, directly or indirectly, with one another (e.g., via one or more buses).

The communications manager 720 may support wireless communication at a UE in accordance with examples as disclosed herein. The joint beam indication manager 725 may be configured as or otherwise support a means for receiving, from a base station, downlink control information including a joint beam indication, the joint beam indication including an indication of a group of transmission configuration indicator states associated with a reference signal. The TCI state manager 730 may be configured as or otherwise support a means for communicating a message on a physical channel using a first transmission configuration indicator state of the group of transmission configuration indicator states. The repetition manager 735 may be configured as or otherwise support a means for communicating a repetition of the message on the physical channel using a second transmission configuration indicator state of the group of transmission configuration indicator states.

In some examples, to support communicating the message, the control message manager 740 may be configured as or otherwise support a means for receiving a control message on a physical downlink control channel, receiving a data message on a physical downlink shared channel, or any combination thereof.

In some examples, the control message manager 740 may be configured as or otherwise support a means for determining, based on the reference signal, quasi co-location information associated with the physical downlink control channel, the physical downlink shared channel, or any combination thereof, where receiving the control message, or the data message, or any combination thereof, are based on the quasi co-location information. In some examples, to support communicating the message, the control message manager 740 may be configured as or otherwise support a means for transmitting a control message on a physical uplink control channel, transmitting a data message on a physical uplink shared channel, or any combination thereof. In some examples, the control message manager 740 may be configured as or otherwise support a means for determining, based on the reference signal, a common uplink transmission spatial filter for the control message or the data message, or any combination thereof, where transmitting the control message, or the data message, or any combination thereof, are based on the common uplink transmission spatial filter.

In some examples, the beam sweeping manager 745 may be configured as or otherwise support a means for performing, based on receiving the downlink control information message, a beam sweep procedure using at least the first transmission configuration indicator state and the second transmission configuration indicator state.

In some examples, the TCI state manager 730 may be configured as or otherwise support a means for comparing a value of a parameter associated with the message with a value of a parameter associated with the repetition of the message. In some examples, the TCI state manager 730 may be configured as or otherwise support a means for selecting the first transmission configuration indicator state for communicating the message and the second transmission configuration indicator state for communicating the repetition of the message based on the comparing. In some examples, to support parameter, the TCI state manager 730 may be configured as or otherwise support a means for a control resource set pool index, a transmission timing, a reception timing, a frequency resource, a resource set identifier, a resource identifier, a resource block index, a panel identifier, or a transmit receive point identifier, or any combination thereof.

In some examples, the repetition manager 735 may be configured as or otherwise support a means for determining a repetition mode for communicating the message and the repetition of the message. In some examples, the repetition manager 735 may be configured as or otherwise support a means for communicating the message and the repetition of the message according to the repetition mode. In some examples, the repetition manager 735 may be configured as or otherwise support a means for receiving, from the base station, an indication of the repetition mode, where the determining of the repetition mode is based on receiving the indication of the repetition mode.

In some examples, to support repetition mode, the repetition manager 735 may be configured as or otherwise support a means for a time division multiplexing mode, a frequency division multiplexing mode, a code division multiplexing mode, a single-frequency network mode, or any combination thereof. In some examples, the repetition manager 735 may be configured as or otherwise support a means for determining that a second physical channel does not support a repetition mode. In some examples, the repetition manager 735 may be configured as or otherwise support a means for communicating a second message on the second physical channel using the first transmission configuration indicator state based on determining that the second physical channel that does not support the repetition mode.

In some examples, the DCI manager 750 may be configured as or otherwise support a means for receiving, from the base station, a second downlink control information message activating the group of transmission configuration indicator states from a set of multiple groups of transmission configuration indicator states, where communicating the message using the first transmission configuration indicator state and communicating the repetition of the message using the second transmission configuration indicator state are based on receiving the second downlink control information message.

In some examples, the DCI manager 750 may be configured as or otherwise support a means for receiving, from the base station, a second downlink control information message adding the group of transmission configuration indicator states to a set of multiple groups of transmission configuration indicator states, or removing a second group of transmission configuration indicator states from the set of multiple groups of transmission configuration indicator states, or any combination thereof, where communicating the message using the first transmission configuration indicator state and communicating the repetition of the message using the second transmission configuration indicator state are based on receiving the second downlink control information message.

In some examples, the CA manager 755 may be configured as or otherwise support a means for receiving, from the base station, carrier aggregation configuration information for operating in a carrier aggregation mode. In some examples, the physical channel is located on a single component carrier. In some examples, the physical channel is located on multiple component carriers. In some examples, the downlink control information message includes a downlink UE-specific downlink control information message, an uplink UE-specific downlink control information message, or a group common downlink control information message.

Additionally, or alternatively, the communications manager 720 may support wireless communications at a UE in accordance with examples as disclosed herein. In some examples, the joint beam indication manager 725 may be configured as or otherwise support a means for receiving, from a base station, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. In some examples, the TCI state manager 730 may be configured as or otherwise support a means for receiving, from the base station using the first group of transmission configuration indicator states, one or more messages on a physical downlink channel. In some examples, the TCI state manager 730 may be configured as or otherwise support a means for transmitting, to the base station using the second group of transmission configuration indicator states, one or more messages on a physical uplink channel.

In some examples, to support receiving the one or more messages on the physical downlink channel, the TCI state manager 730 may be configured as or otherwise support a means for receiving a message on the physical downlink channel using a first transmission configuration indicator state of the first group of transmission configuration indicator states. In some examples, to support receiving the one or more messages on the physical downlink channel, the TCI state manager 730 may be configured as or otherwise support a means for receiving a repetition of the message on the physical downlink channel using a second transmission configuration indicator state of the first group of transmission configuration indicator states. In some examples, the physical downlink channel includes a physical downlink control channel or a physical downlink shared channel.

In some examples, the TCI state manager 730 may be configured as or otherwise support a means for determining, based on the first reference signal, quasi co-location information associated with the physical downlink control channel, the physical downlink shared channel, or any combination thereof, where receiving the message, the repetition of the message, or both, is based on the quasi co-location information.

In some examples, to support transmitting the one or more messages on the physical uplink channel, the TCI state manager 730 may be configured as or otherwise support a means for transmitting a message on the physical uplink channel using a first transmission configuration indicator state of the second group of transmission configuration indicator states. In some examples, to support transmitting the one or more messages on the physical uplink channel, the TCI state manager 730 may be configured as or otherwise support a means for transmitting a repetition of the message on the physical uplink channel using a second transmission configuration indicator state of the second group of transmission configuration indicator states. In some examples, the physical uplink channel includes a physical uplink control channel or a physical uplink shared channel. In some examples, the TCI state manager 730 may be configured as or otherwise support a means for determining, based on the second reference signal, a common uplink transmission spatial filter for a control message or a data message, or any combination thereof, where transmitting the message, the repetition of the message, or both, is based on the common uplink transmission spatial filter.

In some examples, the beam sweeping manager 745 may be configured as or otherwise support a means for performing, based on receiving the downlink control information message, a beam sweep procedure using at least the first group of transmission configuration indicator states and the second group of transmission configuration indicator states.

In some examples, the repetition manager 735 may be configured as or otherwise support a means for determining a first repetition mode for receiving the one or more messages on the physical downlink channel and a second repetition mode for transmitting the one or more messages on the physical uplink channel. In some examples, the repetition manager 735 may be configured as or otherwise support a means for receiving the one or more messages on the physical downlink channel according to the first repetition mode. In some examples, the repetition manager 735 may be configured as or otherwise support a means for transmitting the one or more messages on the physical uplink channel according to the second repetition mode.

In some examples, the repetition manager 735 may be configured as or otherwise support a means for receiving, from the base station, an indication of the first repetition mode for a first set of physical channels including the physical downlink channel. In some examples, the repetition manager 735 may be configured as or otherwise support a means for receiving, from the base station, an indication of the second repetition mode for a second set of physical channels including the physical uplink channel.

In some examples, the first set of physical channels includes a physical downlink control channel and a physical downlink shared channel. In some examples, the second set of physical channels includes a physical uplink control channel and a physical uplink shared channel. In some examples, the first repetition mode includes a time division multiplexing mode, a frequency division multiplexing mode, a code division multiplexing mode, a single-frequency network mode, or any combination thereof. In some examples, the second repetition mode includes a time division multiplexing mode, a frequency division multiplexing mode, a code division multiplexing mode, a single-frequency network mode, or any combination thereof.

In some examples, the repetition manager 735 may be configured as or otherwise support a means for determining that a second physical downlink channel does not support a repetition mode. In some examples, the repetition manager 735 may be configured as or otherwise support a means for receiving, using a first transmission configuration indicator state of the first group of transmission configuration indicator states, one or more messages on the second physical downlink channel based on determining that the second downlink physical channel does not support the repetition mode. In some examples, the repetition manager 735 may be configured as or otherwise support a means for determining that a second physical uplink channel does not support a repetition mode. In some examples, the repetition manager 735 may be configured as or otherwise support a means for transmitting, using a first transmission configuration indicator state of the second group of transmission configuration indicator states, one or more messages on the second physical uplink channel based on determining that the second physical uplink channel does not support the repetition mode.

In some examples, the DCI manager 750 may be configured as or otherwise support a means for receiving, from the base station, one or more additional downlink control information messages activating the first group of transmission configuration indicator states from a set of multiple groups of transmission configuration indicator states, or the second group of transmission configuration indicator states from a set of multiple groups of transmission configuration indicator states, or both, where receiving the one or more messages on the physical downlink channel using the first group of transmission configuration indicator states and transmitting the one or more messages on the physical uplink channel using the second group of transmission configuration indicator states are based on receiving the one or more additional downlink control information messages.

In some examples, the DCI manager 750 may be configured as or otherwise support a means for receiving, from the base station, one or more additional downlink control information messages adding the first group of transmission configuration indicator states to a set of multiple groups of transmission configuration indicator states, or the second group of transmission configuration indicator states to a set of multiple groups of transmission configuration indicator states, or both. In some examples, the DCI manager 750 may be configured as or otherwise support a means for removing a third group of transmission configuration indicator states from the set of multiple groups of transmission configuration indicator states. In some examples, the DCI manager 750 may be configured as or otherwise support a means for or any combination thereof. In some examples, the DCI manager 750 may be configured as or otherwise support a means for where receiving the one or more messages on the physical downlink channel using the first group of transmission configuration indicator states and transmitting the one or more messages on the physical uplink channel using the second group of transmission configuration indicator states are based on receiving the one or more additional downlink control information messages.

In some examples, the physical downlink channel is located on a single component carrier. In some examples, the physical downlink channel is located on multiple component carriers.

In some examples, the CA manager 755 may be configured as or otherwise support a means for receiving, from the base station, carrier aggregation configuration information for operating in a carrier aggregation mode. In some examples, the physical uplink channel is located on one component carrier or multiple component carriers. In some examples, the downlink control information message includes a downlink UE-specific downlink control information message, an uplink UE-specific downlink control information message, or a group common downlink control information message.

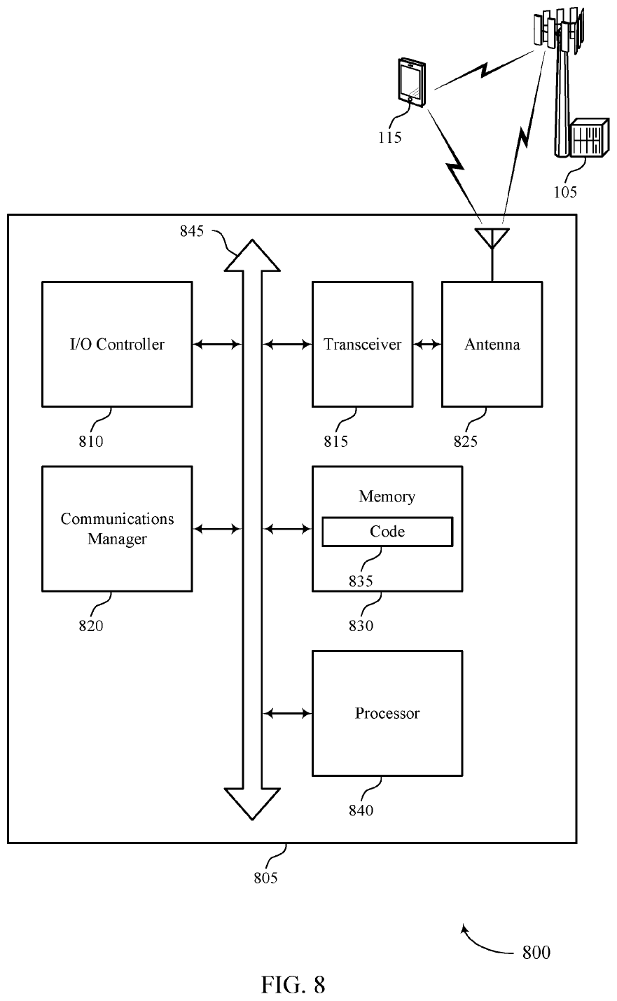

FIG. 8 shows a diagram of a system 800 including a device 805 that supports a unified transmission configuration indicator framework for physical channels in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting a unified transmission configuration indicator framework for physical channels). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, from a base station, downlink control information including a joint beam indication, the joint beam indication including an indication of a group of transmission configuration indicator states associated with a reference signal. The communications manager 820 may be configured as or otherwise support a means for communicating a message on a physical channel using a first transmission configuration indicator state of the group of transmission configuration indicator states. The communications manager 820 may be configured as or otherwise support a means for communicating a repetition of the message on the physical channel using a second transmission configuration indicator state of the group of transmission configuration indicator states.

Additionally, or alternatively, the communications manager 820 may support wireless communications at a UE in accordance with examples as disclosed herein. For example, the communications manager 820 may be configured as or otherwise support a means for receiving, from a base station, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The communications manager 820 may be configured as or otherwise support a means for receiving, from the base station using the first group of transmission configuration indicator states, one or more messages on a physical downlink channel. The communications manager 820 may be configured as or otherwise support a means for transmitting, to the base station using the second group of transmission configuration indicator states, one or more messages on a physical uplink channel.

By including or configuring the communications manager 820 in accordance with examples as described herein, the device 805 may support techniques for unified TCI frameworks such that a UE may more efficiently make use of available system resources, more efficiently use computational resources, reduce signaling overhead, reduce system congestion, and improve user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of a unified transmission configuration indicator framework for physical channels as described herein, or the processor 840 and the memory 830 may be otherwise configured to perform or support such operations.

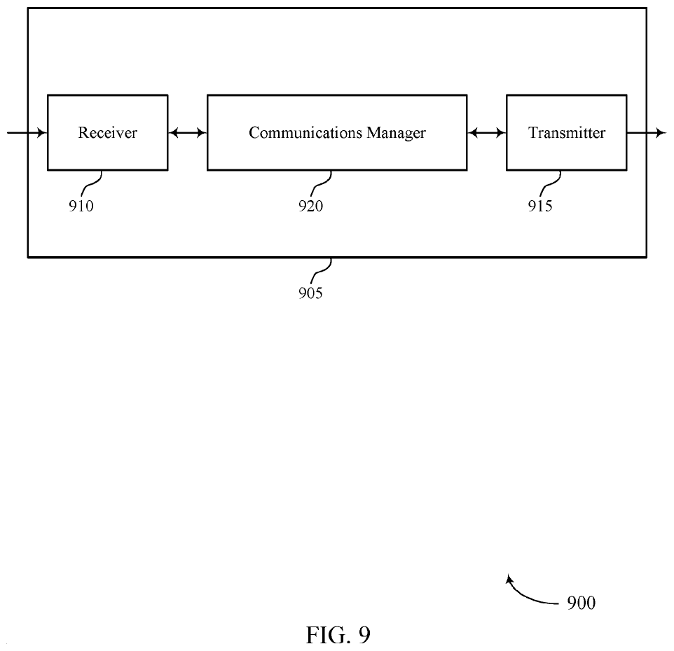

FIG. 9 shows a block diagram 900 of a device 905 that supports a unified transmission configuration indicator framework for physical channels in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to a unified transmission configuration indicator framework for physical channels). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to a unified transmission configuration indicator framework for physical channels). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of a unified transmission configuration indicator framework for physical channels as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, downlink control information including a joint beam indication, the joint beam indication including an indication of a group of transmission configuration indicator states associated with a reference signal. The communications manager 920 may be configured as or otherwise support a means for communicating a message on a physical channel using a first transmission configuration indicator state of the group of transmission configuration indicator states. The communications manager 920 may be configured as or otherwise support a means for communicating a repetition of the message on the physical channel using a second transmission configuration indicator state of the group of transmission configuration indicator states.

Additionally, or alternatively, the communications manager 920 may support wireless communications at a base station in accordance with examples as disclosed herein. For example, the communications manager 920 may be configured as or otherwise support a means for transmitting, to a UE, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The communications manager 920 may be configured as or otherwise support a means for transmitting, to the UE using the first group of transmission configuration indicator states, one or more messages on a physical downlink channel. The communications manager 920 may be configured as or otherwise support a means for receiving, from the UE using the second group of transmission configuration indicator states, one or more messages on a physical uplink channel.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for unified TCI frameworks such that a base station may more efficiently make use of available system resources, more efficiently use computational resources, reduce signaling overhead, reduce system congestion, and improve user experience.

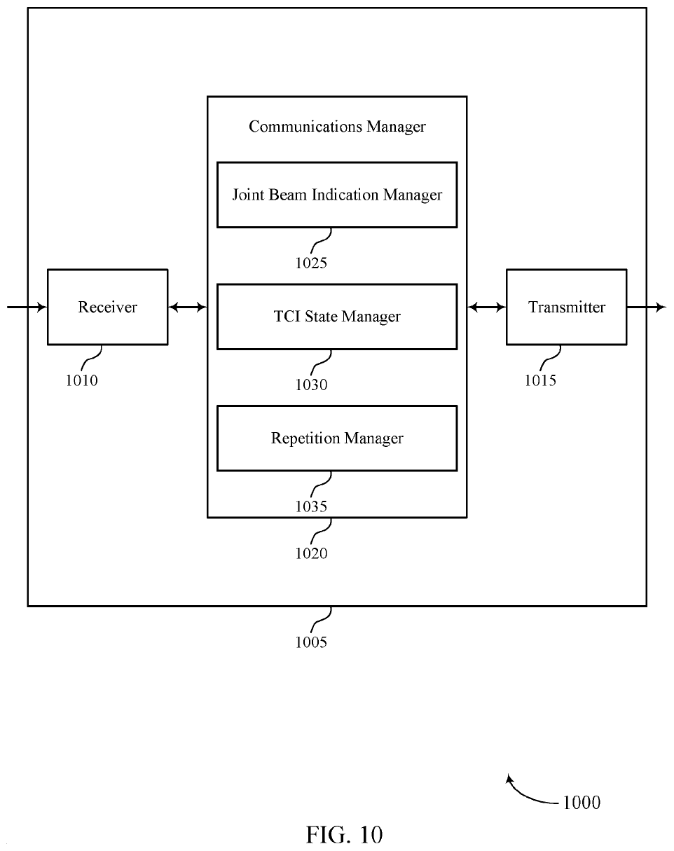

FIG. 10 shows a block diagram 1000 of a device 1005 that supports a unified transmission configuration indicator framework for physical channels in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to a unified transmission configuration indicator framework for physical channels). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to a unified transmission configuration indicator framework for physical channels). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of a unified transmission configuration indicator framework for physical channels as described herein. For example, the communications manager 1020 may include a joint beam indication manager 1025, a TCI state manager 1030, a repetition manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The joint beam indication manager 1025 may be configured as or otherwise support a means for transmitting, to a UE, downlink control information including a joint beam indication, the joint beam indication including an indication of a group of transmission configuration indicator states associated with a reference signal. The TCI state manager 1030 may be configured as or otherwise support a means for communicating a message on a physical channel using a first transmission configuration indicator state of the group of transmission configuration indicator states. The repetition manager 1035 may be configured as or otherwise support a means for communicating a repetition of the message on the physical channel using a second transmission configuration indicator state of the group of transmission configuration indicator states.

Additionally, or alternatively, the communications manager 1020 may support wireless communications at a base station in accordance with examples as disclosed herein. The joint beam indication manager 1025 may be configured as or otherwise support a means for transmitting, to a UE, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The TCI state manager 1030 may be configured as or otherwise support a means for transmitting, to the UE using the first group of transmission configuration indicator states, one or more messages on a physical downlink channel. The TCI state manager 1030 may be configured as or otherwise support a means for receiving, from the UE using the second group of transmission configuration indicator states, one or more messages on a physical uplink channel.

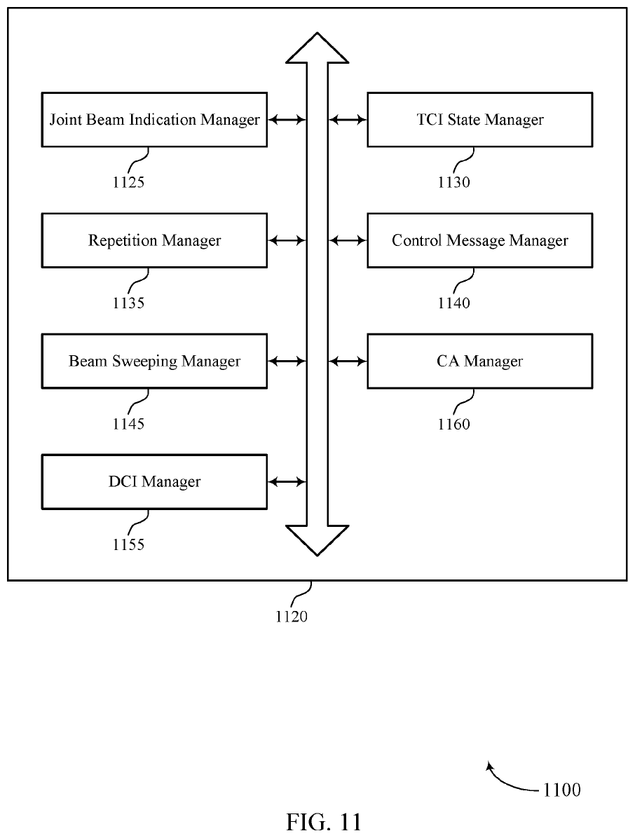

FIG. 11 shows a block diagram 1100 of a communications manager 1120 that supports a unified transmission configuration indicator framework for physical channels in accordance with aspects of the present disclosure. The communications manager 1120 may be an example of aspects of a communications manager 920, a communications manager 1020, or both, as described herein. The communications manager 1120, or various components thereof, may be an example of means for performing various aspects of a unified transmission configuration indicator framework for physical channels as described herein. For example, the communications manager 1120 may include a joint beam indication manager 1125, a TCI state manager 1130, a repetition manager 1135, a control message manager 1140, a beam sweeping manager 1145, a DCI manager 1155, a CA manager 1160, or any combination thereof. Each of these components may communicate, directly or indirectly, with one another (e.g., via one or more buses).

The communications manager 1120 may support wireless communications at a base station in accordance with examples as disclosed herein. The joint beam indication manager 1125 may be configured as or otherwise support a means for transmitting, to a UE, downlink control information including a joint beam indication, the joint beam indication including an indication of a group of transmission configuration indicator states associated with a reference signal. The TCI state manager 1130 may be configured as or otherwise support a means for communicating a message on a physical channel using a first transmission configuration indicator state of the group of transmission configuration indicator states. The repetition manager 1135 may be configured as or otherwise support a means for communicating a repetition of the message on the physical channel using a second transmission configuration indicator state of the group of transmission configuration indicator states.

In some examples, to support communicating the message, the control message manager 1140 may be configured as or otherwise support a means for transmitting a control message on a physical downlink control channel, transmitting a data message on a physical downlink shared channel, or any combination thereof.

In some examples, the TCI state manager 1130 may be configured as or otherwise support a means for determining, based on the reference signal, quasi co-location information associated with the physical downlink control channel, the physical downlink shared channel, or any combination thereof, where transmitting the control message, or the data message, or any combination thereof, are based on the quasi co-location information. In some examples, to support communicating the message, the TCI state manager 1130 may be configured as or otherwise support a means for receiving a control message on a physical uplink control channel, receiving a data message on a physical uplink shared channel, or any combination thereof. In some examples, the TCI state manager 1130 may be configured as or otherwise support a means for determining, based on the reference signal, a common uplink transmission spatial filter for the control message or the data message, or any combination thereof, where receiving the control message, or the data message, or any combination thereof, are based on the common uplink transmission spatial filter.

In some examples, the beam sweeping manager 1145 may be configured as or otherwise support a means for performing, based on transmitting the downlink control information message, a beam sweep procedure using at least the first transmission configuration indicator state and the second transmission configuration indicator state.

In some examples, the repetition manager 1135 may be configured as or otherwise support a means for determining a repetition mode for communicating the message and the repetition of the message. In some examples, repetition manager 1135 may be configured as or otherwise support a means for communicating the message and the repetition of the message according to the repetition mode. In some examples, the repetition manager 1135 may be configured as or otherwise support a means for transmitting, to the UE, an indication of the repetition mode.

In some examples, to support repetition mode, the repetition manager 1135 may be configured as or otherwise support a means for a time division multiplexing mode, a frequency division multiplexing mode, a code division multiplexing mode, a single-frequency network mode, or any combination thereof. In some examples, the repetition manager 1135 may be configured as or otherwise support a means for determining that a second physical channel does not support a repetition mode. In some examples, the repetition manager 1135 may be configured as or otherwise support a means for communicating a second message on the second physical channel using the first transmission configuration indicator state based on determining that the second physical channel that does not support the repetition mode.

In some examples, the DCI manager 1155 may be configured as or otherwise support a means for transmitting, to the UE, a second downlink control information message activating the group of transmission configuration indicator states from a set of multiple groups of transmission configuration indicator states, where communicating the message using the first transmission configuration indicator state and communicating the repetition of the message using the second transmission configuration indicator state are based on transmitting the second downlink control information message.

In some examples, the DCI manager 1155 may be configured as or otherwise support a means for transmitting, to the UE, a second downlink control information message adding the group of transmission configuration indicator states to a set of multiple groups of transmission configuration indicator states, or removing a second group of transmission configuration indicator states from the set of multiple groups of transmission configuration indicator states, or any combination thereof, where communicating the message using the first transmission configuration indicator state and communicating the repetition of the message using the second transmission configuration indicator state are based on transmitting the second downlink control information message.

In some examples, the CA manager 1160 may be configured as or otherwise support a means for transmitting, to the UE, carrier aggregation configuration information for operating in a carrier aggregation mode. In some examples, the physical channel is located on a single component carrier. In some examples, the physical channel is located on multiple component carriers.

In some examples, the downlink control information message includes a downlink UE-specific downlink control information message, an uplink UE-specific downlink control information message, or a group common downlink control information message.

Additionally, or alternatively, the communications manager 1120 may support wireless communications at a base station in accordance with examples as disclosed herein. In some examples, the joint beam indication manager 1125 may be configured as or otherwise support a means for transmitting, to a UE, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. In some examples, the TCI state manager 1130 may be configured as or otherwise support a means for transmitting, to the UE using the first group of transmission configuration indicator states, one or more messages on a physical downlink channel. In some examples, the TCI state manager 1130 may be configured as or otherwise support a means for receiving, from the UE using the second group of transmission configuration indicator states, one or more messages on a physical uplink channel.

In some examples, to support transmitting the one or more messages on the physical downlink channel, the TCI state manager 1130 may be configured as or otherwise support a means for transmitting a message on the physical downlink channel using a first transmission configuration indicator state of the first group of transmission configuration indicator states. In some examples, to support transmitting the one or more messages on the physical downlink channel, the TCI state manager 1130 may be configured as or otherwise support a means for transmitting a repetition of the message on the physical downlink channel using a second transmission configuration indicator state of the first group of transmission configuration indicator states. In some examples, the physical downlink channel includes a physical downlink control channel or a physical downlink shared channel.

In some examples, the TCI state manager 1130 may be configured as or otherwise support a means for determining, based on the first reference signal, quasi co-location information associated with the physical downlink control channel, the physical downlink shared channel, or any combination thereof, where transmitting the message, the repetition of the message, or both, is based on the quasi co-location information.

In some examples, to support transmitting the one or more messages on the physical uplink channel, the TCI state manager 1130 may be configured as or otherwise support a means for receiving a message on the physical uplink channel using a first transmission configuration indicator state of the second group of transmission configuration indicator states. In some examples, to support transmitting the one or more messages on the physical uplink channel, the TCI state manager 1130 may be configured as or otherwise support a means for receiving a repetition of the message on the physical uplink channel using a second transmission configuration indicator state of the second group of transmission configuration indicator states. In some examples, the physical uplink channel includes a physical uplink control channel or a physical uplink shared channel.

In some examples, the beam sweeping manager 1145 may be configured as or otherwise support a means for performing, based on receiving the downlink control information message, a beam sweep procedure using at least the first group of transmission configuration indicator states and the second group of transmission configuration indicator states.

In some examples, the repetition manager 1135 may be configured as or otherwise support a means for determining a first repetition mode for transmitting the one or more messages on the physical downlink channel and a second repetition mode for receiving the one or more messages on the physical uplink channel. In some examples, the repetition manager 1135 may be configured as or otherwise support a means for transmitting the one or more messages on the physical downlink channel according to the first repetition mode. In some examples, the repetition manager 1135 may be configured as or otherwise support a means for receiving the one or more messages on the physical uplink channel according to the second repetition mode.

In some examples, the repetition manager 1135 may be configured as or otherwise support a means for transmitting, to the UE, an indication of the first repetition mode for a first set of physical channels including the physical downlink channel. In some examples, the repetition manager 1135 may be configured as or otherwise support a means for transmitting, to the UE, an indication of the second repetition mode for a second set of physical channels including the physical uplink channel.

In some examples, the first set of physical channels includes a physical downlink control channel and a physical downlink shared channel. In some examples, the second set of physical channels includes a physical uplink control channel and a physical uplink shared channel. In some examples, the first repetition mode includes a time division multiplexing mode, a frequency division multiplexing mode, a code division multiplexing mode, a single-frequency network mode, or any combination thereof. In some examples, the second repetition mode includes a time division multiplexing mode, a frequency division multiplexing mode, a code division multiplexing mode, a single-frequency network mode, or any combination thereof.

In some examples, the repetition manager 1135 may be configured as or otherwise support a means for determining that a second physical downlink channel does not support a repetition mode. In some examples, the repetition manager 1135 may be configured as or otherwise support a means for transmitting, using a first transmission configuration indicator state of the first group of transmission configuration indicator states, one or more messages on the second physical downlink channel based on determining that the second physical downlink channel that does not support the repetition mode. In some examples, the repetition manager 1135 may be configured as or otherwise support a means for determining that a second physical uplink channel does not support a repetition mode. In some examples, the repetition manager 1135 may be configured as or otherwise support a means for receiving, using a first transmission configuration indicator state of the second group of transmission configuration indicator states, one or more messages on the second physical uplink channel based on determining that the second physical uplink channel that does not support the repetition mode.

In some examples, the DCI manager 1155 may be configured as or otherwise support a means for transmitting, to the UE, one or more additional downlink control information messages activating the first group of transmission configuration indicator states from a set of multiple groups of transmission configuration indicator states, or the second group of transmission configuration indicator states from a set of multiple groups of transmission configuration indicator states, or both, where transmitting the one or more messages on the physical downlink channel using the first group of transmission configuration indicator states and receiving the one or more messages on the physical uplink channel using the second group of transmission configuration indicator states are based on transmitting the one or more additional downlink control information messages.

In some examples, the DCI manager 1155 may be configured as or otherwise support a means for transmitting, to the UE, one or more additional downlink control information messages adding the first group of transmission configuration indicator states to a set of multiple groups of transmission configuration indicator states, or the second group of transmission configuration indicator states to a set of multiple groups of transmission configuration indicator states, or both; removing a third group of transmission configuration indicator states from the set of multiple groups of transmission configuration indicator states; removing a third group of transmission configuration indicator states from the set of multiple groups of transmission configuration indicator states; or any combination thereof. In some examples, the DCI manager 1155 may be configured as or otherwise support a means for where receiving the one or more messages on the physical downlink channel using the first group of transmission configuration indicator states and transmitting the one or more messages on the physical uplink channel using the second group of transmission configuration indicator states are based on receiving the one or more additional downlink control information messages.

In some examples, the CA manager 1160 may be configured as or otherwise support a means for transmitting, to the UE, carrier aggregation configuration information for operating in a carrier aggregation mode. In some examples, the physical downlink channel is located on a single component carrier. In some examples, the physical downlink channel is located on multiple component carriers.

In some examples, the physical uplink channel is located on one component carrier or multiple component carriers. In some examples, the downlink control information message includes a downlink UE-specific downlink control information message, an uplink UE-specific downlink control information message, or a group common downlink control information message.

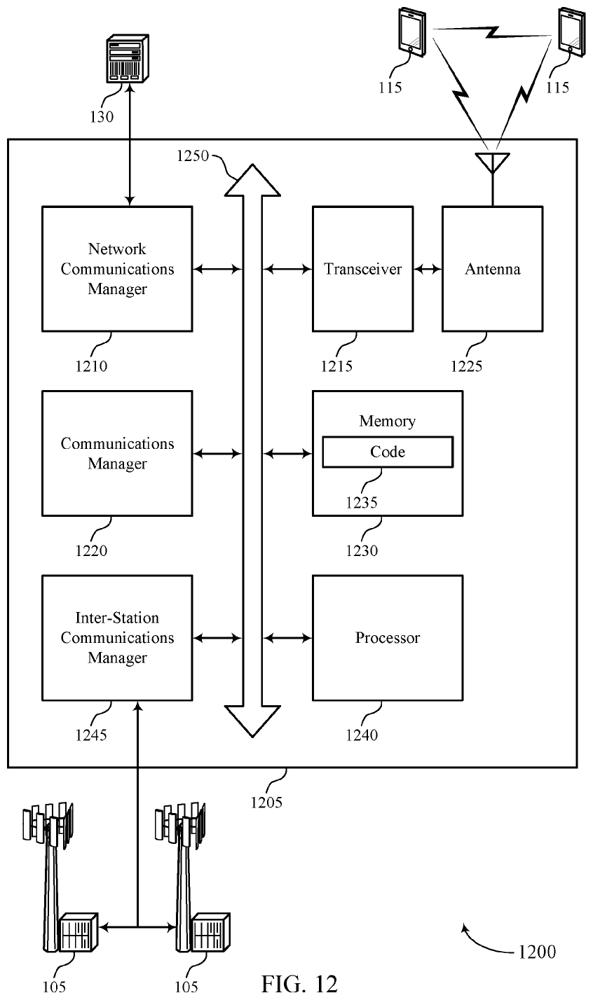

FIG. 12 shows a diagram of a system 1200 including a device 1205 that supports a unified transmission configuration indicator framework for physical channels in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting a unified transmission configuration indicator framework for physical channels). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, downlink control information including a joint beam indication, the joint beam indication including an indication of a group of transmission configuration indicator states associated with a reference signal. The communications manager 1220 may be configured as or otherwise support a means for communicating a message on a physical channel using a first transmission configuration indicator state of the group of transmission configuration indicator states. The communications manager 1220 may be configured as or otherwise support a means for communicating a repetition of the message on the physical channel using a second transmission configuration indicator state of the group of transmission configuration indicator states.

Additionally, or alternatively, the communications manager 1220 may support wireless communications at a base station in accordance with examples as disclosed herein. For example, the communications manager 1220 may be configured as or otherwise support a means for transmitting, to a UE, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The communications manager 1220 may be configured as or otherwise support a means for transmitting, to the UE using the first group of transmission configuration indicator states, one or more messages on a physical downlink channel. The communications manager 1220 may be configured as or otherwise support a means for receiving, from the UE using the second group of transmission configuration indicator states, one or more messages on a physical uplink channel.

By including or configuring the communications manager 1220 in accordance with examples as described herein, the device 1205 may support techniques for unified TCI frameworks such that a base station may more efficiently make use of available system resources, more efficiently use computational resources, reduce signaling overhead, reduce system congestion, and improve user experience.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of a unified transmission configuration indicator framework for physical channels as described herein, or the processor 1240 and the memory 1230 may be otherwise configured to perform or support such operations.

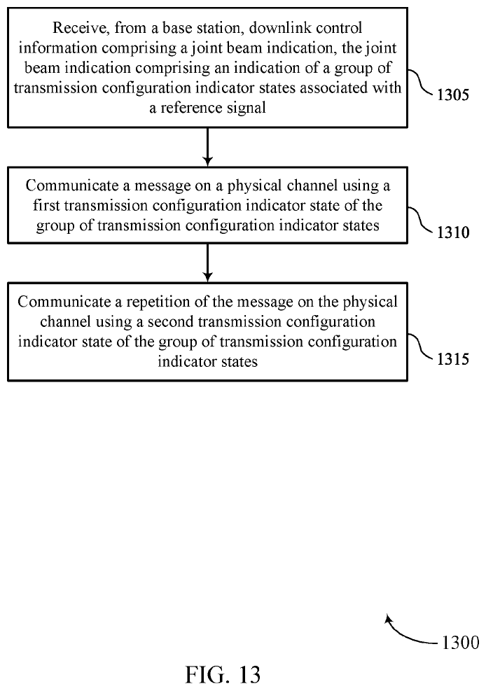

FIG. 13 shows a flowchart illustrating a method 1300 that supports a unified transmission configuration indicator framework for physical channels in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a base station, downlink control information including a joint beam indication, the joint beam indication including an indication of a group of transmission configuration indicator states associated with a reference signal. The operations of 1305 may be performed in accordance with examples as disclosed herein. In some examples, aspects of the operations of 1305 may be performed by a joint beam indication manager 725 as described with reference to FIG. 7.

At 1310, the method may include communicating a message on a physical channel using a first transmission configuration indicator state of the group of transmission configuration indicator states. The operations of 1310 may be performed in accordance with examples as disclosed herein. In some examples, aspects of the operations of 1310 may be performed by a TCI state manager 730 as described with reference to FIG. 7.

At 1315, the method may include communicating a repetition of the message on the physical channel using a second transmission configuration indicator state of the group of transmission configuration indicator states. The operations of 1315 may be performed in accordance with examples as disclosed herein. In some examples, aspects of the operations of 1315 may be performed by a repetition manager 735 as described with reference to FIG. 7.

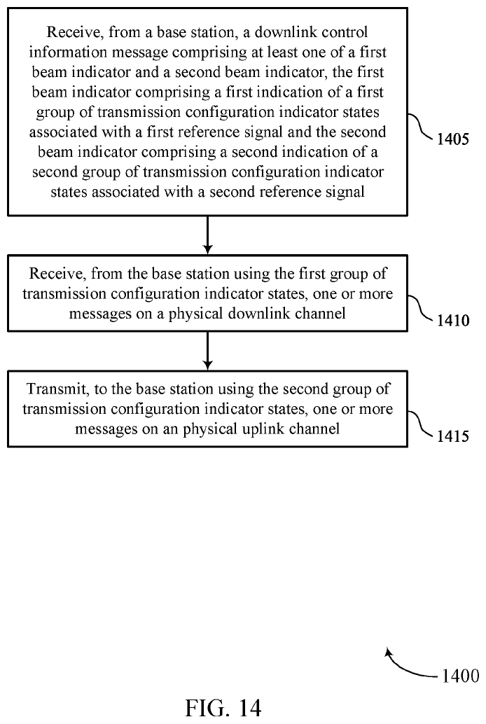

FIG. 14 shows a flowchart illustrating a method 1400 that supports a unified transmission configuration indicator framework for physical channels in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a base station, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The operations of 1405 may be performed in accordance with examples as disclosed herein. In some examples, aspects of the operations of 1405 may be performed by a joint beam indication manager 725 as described with reference to FIG. 7.

At 1410, the method may include receiving, from the base station using the first group of transmission configuration indicator states, one or more messages on a physical downlink channel. The operations of 1410 may be performed in accordance with examples as disclosed herein. In some examples, aspects of the operations of 1410 may be performed by a TCI state manager 730 as described with reference to FIG. 7.

At 1415, the method may include transmitting, to the base station using the second group of transmission configuration indicator states, one or more messages on a physical uplink channel. The operations of 1415 may be performed in accordance with examples as disclosed herein. In some examples, aspects of the operations of 1415 may be performed by a TCI state manager 730 as described with reference to FIG. 7.

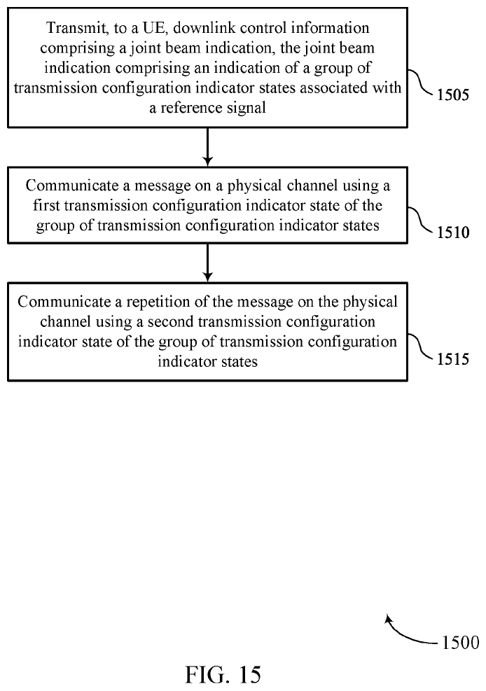

FIG. 15 shows a flowchart illustrating a method 1500 that supports a unified transmission configuration indicator framework for physical channels in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally, or alternatively, the base station may perform aspects of the described functions using special-purpose hardware.

At 1505, the method may include transmitting, to a UE, downlink control information including a joint beam indication, the joint beam indication including an indication of a group of transmission configuration indicator states associated with a reference signal. The operations of 1505 may be performed in accordance with examples as disclosed herein. In some examples, aspects of the operations of 1505 may be performed by a joint beam indication manager 1125 as described with reference to FIG. 11.

At 1510, the method may include communicating a message on a physical channel using a first transmission configuration indicator state of the group of transmission configuration indicator states. The operations of 1510 may be performed in accordance with examples as disclosed herein. In some examples, aspects of the operations of 1510 may be performed by a TCI state manager 1130 as described with reference to FIG. 11.

At 1515, the method may include communicating a repetition of the message on the physical channel using a second transmission configuration indicator state of the group of transmission configuration indicator states. The operations of 1515 may be performed in accordance with examples as disclosed herein. In some examples, aspects of the operations of 1515 may be performed by a repetition manager 1135 as described with reference to FIG. 11.

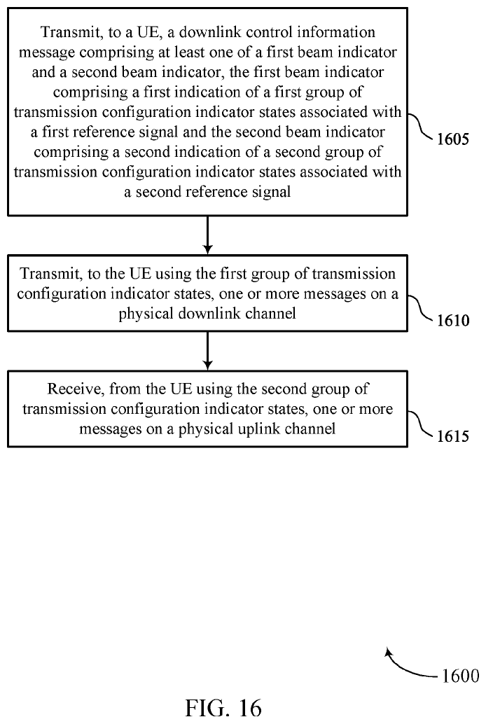

FIG. 16 shows a flowchart illustrating a method 1600 that supports a unified transmission configuration indicator framework for physical channels in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally, or alternatively, the base station may perform aspects of the described functions using special-purpose hardware.

At 1605, the method may include transmitting, to a UE, a downlink control information message including at least one of a first beam indication and a second beam indication, the first beam indication including a first indication of a first group of transmission configuration indicator states associated with a first reference signal and the second beam indication including a second indication of a second group of transmission configuration indicator states associated with a second reference signal. The operations of 1605 may be performed in accordance with examples as disclosed herein. In some examples, aspects of the operations of 1605 may be performed by a joint beam indication manager 1125 as described with reference to FIG. 11.

At 1610, the method may include transmitting, to the UE using the first group of transmission configuration indicator states, one or more messages on a physical downlink channel. The operations of 1610 may be performed in accordance with examples as disclosed herein. In some examples, aspects of the operations of 1610 may be performed by a TCI state manager 1130 as described with reference to FIG. 11.

At 1615, the method may include receiving, from the UE using the second group of transmission configuration indicator states, one or more messages on a physical uplink channel. The operations of 1615 may be performed in accordance with examples as disclosed herein. In some examples, aspects of the operations of 1615 may be performed by a TCI state manager 1130 as described with reference to FIG. 11.

The following provides an overview of aspects of the present disclosure:

Aspect 1: A method for wireless communication at a UE, comprising: receiving, from a base station, downlink control information comprising a joint beam indication, the joint beam indication comprising an indication of a group of transmission configuration indicator states associated with a reference signal; communicating a message on a physical channel using a first transmission configuration indicator state of the group of transmission configuration indicator states; and communicating a repetition of the message on the physical channel using a second transmission configuration indicator state of the group of transmission configuration indicator states.

Aspect 2: The method of aspect 1, wherein communicating the message comprises: receiving a control message on a physical downlink control channel, receiving a data message on a physical downlink shared channel, or any combination thereof.

Aspect 3: The method of aspect 2, further comprising: determining, based at least in part on the reference signal, quasi co-location information associated with the physical downlink control channel, the physical downlink shared channel, or any combination thereof, wherein receiving the control message, or the data message, or any combination thereof, are based at least in part on the quasi co-location information.

Aspect 4: The method of any of aspects 1 through 3, wherein communicating the message comprises: transmitting a control message on an physical uplink control channel, transmitting a data message on a physical uplink shared channel, or any combination thereof.

Aspect 5: The method of aspect 4, further comprising: determining, based at least in part on the reference signal, a common uplink transmission spatial filter for the control message or the data message, or any combination thereof, wherein transmitting the control message, or the data message, or any combination thereof, are based at least in part on the common uplink transmission spatial filter.

Aspect 6: The method of any of aspects 1 through 5, further comprising: performing, based at least in part on receiving the downlink control information message, a beam sweep procedure using at least the first transmission configuration indicator state and the second transmission configuration indicator state.

Aspect 7: The method of any of aspects 1 through 6, further comprising: comparing a value of a parameter associated with the message with a value of a parameter associated with the repetition of the message; and selecting the first transmission configuration indicator state for communicating the message and the second transmission configuration indicator state for communicating the repetition of the message based at least in part on the comparing.

Aspect 8: The method of aspect 7, wherein the parameter comprises: a control resource set pool index, a transmission timing, a reception timing, a frequency resource, a resource set identifier, a resource identifier, a resource block index, a panel identifier, or a transmit receive point identifier, or any combination thereof.

Aspect 9: The method of any of aspects 1 through 8, further comprising: determining a repetition mode for communicating the message and the repetition of the message; and communicating the message and the repetition of the message according to the repetition mode.

Aspect 10: The method of aspect 9, further comprising: receiving, from the base station, an indication of the repetition mode, wherein the determining of the repetition mode is based at least in part on receiving the indication of the repetition mode.

Aspect 11: The method of any of aspects 9 through 10, wherein the repetition mode comprises: a time division multiplexing mode, a frequency division multiplexing mode, a code division multiplexing mode, a single-frequency network mode, or any combination thereof.

Aspect 12: The method of any of aspects 1 through 11, further comprising: determining that a second physical channel that does not support a repetition mode; and communicating a second message on the second physical channel using the first transmission configuration indicator state based at least in part on determining that the second physical channel that does not support the repetition mode.

Aspect 13: The method of any of aspects 1 through 12, further comprising: receiving, from the base station, a second downlink control information message activating the group of transmission configuration indicator states from a plurality of groups of transmission configuration indicator states, wherein communicating the message using the first transmission configuration indicator state and communicating the repetition of the message using the second transmission configuration indicator state are based at least in part on receiving the second downlink control information message.

Aspect 14: The method of any of aspects 1 through 13, further comprising: receiving, from the base station, a second downlink control information message adding the group of transmission configuration indicator states to a plurality of groups of transmission configuration indicator states, or removing a second group of transmission configuration indicator states from the plurality of groups of transmission configuration indicator states, or any combination thereof, wherein communicating the message using the first transmission configuration indicator state and communicating the repetition of the message using the second transmission configuration indicator state are based at least in part on receiving the second downlink control information message.

Aspect 15: The method of any of aspects 1 through 14, wherein the physical channel is located on a single component carrier.

Aspect 16: The method of any of aspects 1 through 15, wherein the physical channel is located on multiple component carriers.

Aspect 17: The method of any of aspects 1 through 16, further comprising: receiving, from the base station, carrier aggregation configuration information for operating in a carrier aggregation mode.

Aspect 18: The method of any of aspects 1 through 17, wherein the downlink control information message comprises a downlink UE-specific downlink control information message, an uplink UE-specific downlink control information message, or a group common downlink control information message.

Aspect 19: A method for wireless communications at a UE, comprising: receiving, from a base station, a downlink control information message comprising at least one of a first beam indicator and a second beam indicator, the first beam indicator comprising a first indication of a first group of transmission configuration indicator states associated with a first reference signal and the second beam indicator comprising a second indication of a second group of transmission configuration indicator states associated with a second reference signal; receiving, from the base station using the first group of transmission configuration indicator states, one or more messages on a physical downlink channel; and transmitting, to the base station using the second group of transmission configuration indicator states, one or more messages on an physical uplink channel.

Aspect 20: The method of aspect 19, wherein receiving the one or more messages on the physical downlink channel comprises: receiving a message on the physical downlink channel using a first transmission configuration indicator state of the first group of transmission configuration indicator states; and receiving a repetition of the message on the physical downlink channel using a second transmission configuration indicator state of the first group of transmission configuration indicator states.

Aspect 21: The method of aspect 20, wherein the physical downlink channel comprises a physical downlink control channel or a physical downlink shared channel.

Aspect 22: The method of aspect 21, further comprising: determining, based at least in part on the first reference signal, quasi co-location information associated with the physical downlink control channel, the physical downlink shared channel, or any combination thereof, wherein receiving the message, the repetition of the message, or both, is based at least in part on the quasi co-location information.

Aspect 23: The method of any of aspects 19 through 22, wherein transmitting the one or more messages on the physical uplink channel comprises: transmitting a message on the physical uplink channel using a first transmission configuration indicator state of the second group of transmission configuration indicator states; and transmitting a repetition of the message on the physical uplink channel using a second transmission configuration indicator state of the second group of transmission configuration indicator states.

Aspect 24: The method of aspect 23, wherein the physical uplink channel comprises a physical uplink control channel or a physical uplink shared channel.

Aspect 25: The method of aspect 24, further comprising: determining, based at least in part on the second reference signal, a common uplink transmission spatial filter for a control message or a data message, or any combination thereof, wherein transmitting the message, the repetition of the message, or both, is based at least in part on the common uplink transmission spatial filter.

Aspect 26: The method of any of aspects 19 through 25, further comprising: performing, based at least in part on receiving the downlink control information message, a beam sweep procedure using at least the first group of transmission configuration indicator states and the second group of transmission configuration indicator states.

Aspect 27: The method of any of aspects 19 through 26, further comprising: determining a first repetition mode for receiving the one or more messages on the physical downlink channel and a second repetition mode for transmitting the one or more messages on the physical uplink channel; receiving the one or more messages on the physical downlink channel according to the first repetition mode; and transmitting the one or more messages on the physical uplink channel according to the second repetition mode.

Aspect 28: The method of aspect 27, further comprising: receiving, from the base station, an indication of the first repetition mode for a first set of physical channels comprising the physical downlink channel; and receiving, from the base station, an indication of the second repetition mode for a second set of physical channels comprising the physical uplink channel.

Aspect 29: The method of aspect 28, wherein the first set of physical channels comprises a physical downlink control channel and a physical downlink shared channel; and the second set of physical channels comprises a physical uplink control channel and a physical uplink shared channel.

Aspect 30: The method of any of aspects 28 through 29, wherein the first repetition mode comprises a time division multiplexing mode, a frequency division multiplexing mode, a code division multiplexing mode, a single-frequency network mode, or any combination thereof; and the second repetition mode comprises a time division multiplexing mode, a frequency division multiplexing mode, a code division multiplexing mode, a single-frequency network mode, or any combination thereof.

Aspect 31: The method of any of aspects 19 through 30, further comprising: determining that a second physical downlink channel does not support a repetition mode; and receiving, using a first transmission configuration indicator state of the first group of transmission configuration indicator states, one or more messages on the second physical downlink channel based at least in part on determining that the second downlink physical channel does not support the repetition mode.

Aspect 32: The method of any of aspects 19 through 31, further comprising: determining that a second physical uplink channel does not support a repetition mode; and transmitting, using a first transmission configuration indicator state of the second group of transmission configuration indicator states, one or more messages on the second physical uplink channel based at least in part on determining that the second physical uplink channel does not support the repetition mode.

Aspect 33: The method of any of aspects 19 through 32, further comprising: receiving, from the base station, one or more additional downlink control information messages activating the first group of transmission configuration indicator states from a plurality of groups of transmission configuration indicator states, or the second group of transmission configuration indicator states from a plurality of groups of transmission configuration indicator states, or both, wherein receiving the one or more messages on the physical downlink channel using the first group of transmission configuration indicator states and transmitting the one or more messages on the physical uplink channel using the second group of transmission configuration indicator states are based at least in part on receiving the one or more additional downlink control information messages.

Aspect 34: The method of any of aspects 19 through 33, further comprising: receiving, from the base station, one or more additional downlink control information messages adding the first group of transmission configuration indicator states to a plurality of groups of transmission configuration indicator states, or the second group of transmission configuration indicator states to a plurality of groups of transmission configuration indicator states, or both; removing a third group of transmission configuration indicator states from the plurality of groups of transmission configuration indicator states; or any combination thereof; and wherein receiving the one or more messages on the physical downlink channel using the first group of transmission configuration indicator states and transmitting the one or more messages on the physical uplink channel using the second group of transmission configuration indicator states are based at least in part on receiving the one or more additional downlink control information messages.

Aspect 35: The method of any of aspects 19 through 34, wherein the physical downlink channel is located on a single component carrier.

Aspect 36: The method of any of aspects 19 through 35, wherein the physical downlink channel is located on multiple component carriers.

Aspect 37: The method of any of aspects 19 through 36, further comprising: receiving, from the base station, carrier aggregation configuration information for operating in a carrier aggregation mode.

Aspect 38: The method of any of aspects 19 through 37, wherein the physical uplink channel is located on one component carrier or multiple component carriers.

Aspect 39: The method of any of aspects 19 through 38, wherein the downlink control information message comprises a downlink UE-specific downlink control information message, an uplink UE-specific downlink control information message, or a group common downlink control information message.

Aspect 40: A method for wireless communications at a base station, comprising: transmitting, to a UE, downlink control information comprising a joint beam indication, the joint beam indication comprising an indication of a group of transmission configuration indicator states associated with a reference signal; communicating a message on a physical channel using a first transmission configuration indicator state of the group of transmission configuration indicator states; and communicating a repetition of the message on the physical channel using a second transmission configuration indicator state of the group of transmission configuration indicator states.

Aspect 41: The method of aspect 40, wherein communicating the message comprises: transmitting a control message on a physical downlink control channel, transmitting a data message on a physical downlink shared channel, or any combination thereof.

Aspect 42: The method of aspect 41, further comprising: determining, based at least in part on the reference signal, quasi co-location information associated with the physical downlink control channel, the physical downlink shared channel, or any combination thereof, wherein transmitting the control message, or the data message, or any combination thereof, are based at least in part on the quasi co-location information.

Aspect 43: The method of any of aspects 40 through 42, wherein communicating the message comprises: receiving a control message on an physical uplink control channel, receiving a data message on a physical uplink shared channel, or any combination thereof.

Aspect 44: The method of aspect 43, further comprising: determining, based at least in part on the reference signal, a common uplink transmission spatial filter for the control message or the data message, or any combination thereof, wherein receiving the control message, or the data message, or any combination thereof, are based at least in part on the common uplink transmission spatial filter.

Aspect 45: The method of any of aspects 40 through 44, further comprising: performing, based at least in part on transmitting the downlink control information message, a beam sweep procedure using at least the first transmission configuration indicator state and the second transmission configuration indicator state.

Aspect 46: The method of any of aspects 40 through 45, further comprising: determining a repetition mode for communicating the message and the repetition of the message; and communicating the message and the repetition of the message according to the repetition mode.

Aspect 47: The method of aspect 46, further comprising: transmitting, to the UE, an indication of the repetition mode.

Aspect 48: The method of any of aspects 46 through 47, wherein the repetition mode comprises: a time division multiplexing mode, a frequency division multiplexing mode, a code division multiplexing mode, a single-frequency network mode, or any combination thereof.

Aspect 49: The method of any of aspects 40 through 48, further comprising: determining that a second physical channel that does not support a repetition mode; and communicating a second message on the second physical channel using the first transmission configuration indicator state based at least in part on determining that the second physical channel that does not support the repetition mode.

Aspect 50: The method of any of aspects 40 through 49, further comprising: transmitting, to the UE, a second downlink control information message activating the group of transmission configuration indicator states from a plurality of groups of transmission configuration indicator states, wherein communicating the message using the first transmission configuration indicator state and communicating the repetition of the message using the second transmission configuration indicator state are based at least in part on transmitting the second downlink control information message.

Aspect 51: The method of any of aspects 40 through 50, further comprising: transmitting, to the UE, a second downlink control information message adding the group of transmission configuration indicator states to a plurality of groups of transmission configuration indicator states, or removing a second group of transmission configuration indicator states from the plurality of groups of transmission configuration indicator states, or any combination thereof, wherein communicating the message using the first transmission configuration indicator state and communicating the repetition of the message using the second transmission configuration indicator state are based at least in part on transmitting the second downlink control information message.

Aspect 52: The method of any of aspects 40 through 51, wherein the physical channel is located on a single component carrier.

Aspect 53: The method of any of aspects 40 through 52, wherein the physical channel is located on multiple component carriers.

Aspect 54: The method of any of aspects 40 through 53, further comprising: transmitting, to the UE, carrier aggregation configuration information for operating in a carrier aggregation mode.

Aspect 55: The method of any of aspects 40 through 54, wherein the downlink control information message comprises a downlink UE-specific downlink control information message, an uplink UE-specific downlink control information message, or a group common downlink control information message.

Aspect 56: A method for wireless communications at a base station, comprising: transmitting, to a UE, a downlink control information message comprising at least one of a first beam indicator and a second beam indicator, the first beam indicator comprising a first indication of a first group of transmission configuration indicator states associated with a first reference signal and the second beam indicator comprising a second indication of a second group of transmission configuration indicator states associated with a second reference signal; transmitting, to the UE using the first group of transmission configuration indicator states, one or more messages on a physical downlink channel; and receiving, from the UE using the second group of transmission configuration indicator states, one or more messages on a physical uplink channel.

Aspect 57: The method of aspect 56, wherein transmitting the one or more messages on the physical downlink channel comprises: transmitting a message on the physical downlink channel using a first transmission configuration indicator state of the first group of transmission configuration indicator states; and transmitting a repetition of the message on the physical downlink channel using a second transmission configuration indicator state of the first group of transmission configuration indicator states.

Aspect 58: The method of aspect 57, wherein the physical downlink channel comprises a physical downlink control channel or a physical downlink shared channel.

Aspect 59: The method of aspect 58, further comprising: determining, based at least in part on the first reference signal, quasi co-location information associated with the physical downlink control channel, the physical downlink shared channel, or any combination thereof, wherein transmitting the message, the repetition of the message, or both, is based at least in part on the quasi co-location information.

Aspect 60: The method of any of aspects 56 through 59, wherein transmitting the one or more messages on the physical uplink channel comprises: receiving a message on the physical uplink channel using a first transmission configuration indicator state of the second group of transmission configuration indicator states; and receiving a repetition of the message on the physical uplink channel using a second transmission configuration indicator state of the second group of transmission configuration indicator states.

Aspect 61: The method of aspect 60, wherein the physical uplink channel comprises a physical uplink control channel or a physical uplink shared channel.

Aspect 62: The method of any of aspects 56 through 61, further comprising: performing, based at least in part on receiving the downlink control information message, a beam sweep procedure using at least the first group of transmission configuration indicator states and the second group of transmission configuration indicator states.

Aspect 63: The method of any of aspects 56 through 62, further comprising: determining a first repetition mode for transmitting the one or more messages on the physical downlink channel and a second repetition mode for receiving the one or more messages on the physical uplink channel; transmitting the one or more messages on the physical downlink channel according to the first repetition mode; and receiving the one or more messages on the physical uplink channel according to the second repetition mode.

Aspect 64: The method of aspect 63, further comprising: transmitting, to the UE, an indication of the first repetition mode for a first set of physical channels comprising the physical downlink channel; and transmitting, to the UE, an indication of the second repetition mode for a second set of physical channels comprising the physical uplink channel.

Aspect 65: The method of aspect 64, wherein the first set of physical channels comprises a physical downlink control channel and a physical downlink shared channel; and the second set of physical channels comprises a physical uplink control channel and a physical uplink shared channel.

Aspect 66: The method of any of aspects 64 through 65, wherein the first repetition mode comprises a time division multiplexing mode, a frequency division multiplexing mode, a code division multiplexing mode, a single-frequency network mode, or any combination thereof; and the second repetition mode comprises a time division multiplexing mode, a frequency division multiplexing mode, a code division multiplexing mode, a single-frequency network mode, or any combination thereof.

Aspect 67: The method of any of aspects 56 through 66, further comprising: determining that a second physical downlink channel does not support a repetition mode; and transmitting, using a first transmission configuration indicator state of the first group of transmission configuration indicator states, one or more messages on the second physical downlink channel based at least in part on determining that the second physical downlink channel that does not support the repetition mode.

Aspect 68: The method of any of aspects 56 through 67, further comprising: determining that a second physical uplink channel does not support a repetition mode; and receiving, using a first transmission configuration indicator state of the second group of transmission configuration indicator states, one or more messages on the second physical uplink channel based at least in part on determining that the second physical uplink channel that does not support the repetition mode.

Aspect 69: The method of any of aspects 56 through 68, further comprising: transmitting, to the UE, one or more additional downlink control information messages activating the first group of transmission configuration indicator states from a plurality of groups of transmission configuration indicator states, or the second group of transmission configuration indicator states from a plurality of groups of transmission configuration indicator states, or both, wherein transmitting the one or more messages on the physical downlink channel using the first group of transmission configuration indicator states and receiving the one or more messages on the physical uplink channel using the second group of transmission configuration indicator states are based at least in part on transmitting the one or more additional downlink control information messages.

Aspect 70: The method of any of aspects 56 through 69, further comprising: transmitting, to the UE, one or more additional downlink control information messages adding the first group of transmission configuration indicator states to a plurality of groups of transmission configuration indicator states, or the second group of transmission configuration indicator states to a plurality of groups of transmission configuration indicator states, or both; removing a third group of transmission configuration indicator states from the plurality of groups of transmission configuration indicator states; removing a third group of transmission configuration indicator states from the plurality of groups of transmission configuration indicator states; or any combination thereof; and wherein receiving the one or more messages on the physical downlink channel using the first group of transmission configuration indicator states and transmitting the one or more messages on the physical uplink channel using the second group of transmission configuration indicator states are based at least in part on receiving the one or more additional downlink control information messages.

Aspect 71: The method of any of aspects 56 through 70, wherein the physical downlink channel is located on a single component carrier.

Aspect 72: The method of any of aspects 56 through 71, wherein the physical downlink channel is located on multiple component carriers.

Aspect 73: The method of any of aspects 56 through 72, further comprising: transmitting, to the UE, carrier aggregation configuration information for operating in a carrier aggregation mode.

Aspect 74: The method of any of aspects 56 through 73, wherein the physical uplink channel is located on one component carrier or multiple component carriers.

Aspect 75: The method of any of aspects 56 through 74, wherein the downlink control information message comprises a downlink UE-specific downlink control information message, an uplink UE-specific downlink control information message, or a group common downlink control information message.

Aspect 76: An apparatus for wireless communication at a UE, comprising a processor; memory coupled with the processor; and instructions stored in the memory and executable by the processor to cause the apparatus to perform a method of any of aspects 1 through 18.

Aspect 77: An apparatus for wireless communication at a UE, comprising at least one means for performing a method of any of aspects 1 through 18.

Aspect 78: A non-transitory computer-readable medium storing code for wireless communication at a UE, the code comprising instructions executable by a processor to perform a method of any of aspects 1 through 18.

Aspect 79: An apparatus for wireless communications at a UE, comprising a processor; memory coupled with the processor; and instructions stored in the memory and executable by the processor to cause the apparatus to perform a method of any of aspects 19 through 39.

Aspect 80: An apparatus for wireless communications at a UE, comprising at least one means for performing a method of any of aspects 19 through 39.

Aspect 81: A non-transitory computer-readable medium storing code for wireless communications at a UE, the code comprising instructions executable by a processor to perform a method of any of aspects 19 through 39.

Aspect 82: An apparatus for wireless communications at a base station, comprising a processor; memory coupled with the processor; and instructions stored in the memory and executable by the processor to cause the apparatus to perform a method of any of aspects 40 through 55.

Aspect 83: An apparatus for wireless communications at a base station, comprising at least one means for performing a method of any of aspects 40 through 55.

Aspect 84: A non-transitory computer-readable medium storing code for wireless communications at a base station, the code comprising instructions executable by a processor to perform a method of any of aspects 40 through 55.

Aspect 85: An apparatus for wireless communications at a base station, comprising a processor; memory coupled with the processor; and instructions stored in the memory and executable by the processor to cause the apparatus to perform a method of any of aspects 56 through 75.

Aspect 86: An apparatus for wireless communications at a base station, comprising at least one means for performing a method of any of aspects 56 through 75.

Aspect 87: A non-transitory computer-readable medium storing code for wireless communications at a base station, the code comprising instructions executable by a processor to perform a method of any of aspects 56 through 75.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
one or more memories; and
one or more processors coupled with the one or more memories, the one or more processors configured to cause the apparatus to:
receive, from a base station, downlink control information comprising a joint beam indication, the joint beam indication comprising an indication of a group of transmission configuration indicator states associated with a reference signal;
communicate a message on a physical channel using a first transmission configuration indicator state of the group of transmission configuration indicator states; and
communicate a repetition of the message on the physical channel using a second transmission configuration indicator state of the group of transmission configuration indicator states.

2. The apparatus of claim 1, wherein the one or more processors are further configured to cause the apparatus to:
receive a control message on a physical downlink control channel, receiving a data message on a physical downlink shared channel, or any combination thereof.

3. (canceled)

4. The apparatus of claim 1, wherein the one or more processors are further configured to cause the apparatus to:
transmit a control message on a physical uplink control channel, transmit a data message on a physical uplink shared channel, or any combination thereof.

5. (canceled)

6. The apparatus of claim 1, wherein the one or more processors are further configured to cause the apparatus to:
perform, based at least in part on receiving the downlink control information message, a beam sweep procedure using at least the first transmission configuration indicator state and the second transmission configuration indicator state.

7. The apparatus of claim 1, wherein the one or more processors are further configured to cause the apparatus to:
compare a value of a parameter associated with the message with a value of a parameter associated with the repetition of the message; and
select the first transmission configuration indicator state for communicating the message and the second transmission configuration indicator state for communicating the repetition of the message based at least in part on the comparing.

8. The apparatus of claim 7, wherein the parameter comprises:
a control resource set pool index, a transmission timing, a reception timing, a frequency resource, a resource set identifier, a resource identifier, a resource block index, a panel identifier, or a transmit receive point identifier, or any combination thereof.

9. The apparatus of claim 1, the one or more processors are further configured to cause the apparatus to:
determine a repetition mode for communicating the message and the repetition of the message; and
communicate the message and the repetition of the message according to the repetition mode.

10-11. (canceled)

12. The apparatus of claim 1, wherein the one or more processors are further configured to cause the apparatus to:
determine that a second physical channel does not support a repetition mode; and
communicate a second message on the second physical channel using the first transmission configuration indicator state based at least in part on determining that the second physical channel that does not support the repetition mode.

13-14. (canceled)

15. The apparatus of claim 1, wherein the physical channel is located on a single component carrier.

16. The apparatus of claim 1, wherein the physical channel is located on multiple component carriers.

17. (canceled)

18. The apparatus of claim 1, wherein the downlink control information message comprises a downlink UE-specific downlink control information message, an uplink UE-specific downlink control information message, or a group common downlink control information message.

19. An apparatus for wireless communications at a user equipment (UE), comprising:
one or more memories; and
one or more processor coupled with the one or more memories, the one or more processors configured to cause the apparatus to:
receive, from a base station, a downlink control information message comprising at least one of a first beam indication and a second beam indication, the first beam indication comprising a first indication of a first group of transmission configuration indicator states associated with a first reference signal and the second beam indication comprising a second indication of a second group of transmission configuration indicator states associated with a second reference signal;
receive, from the base station using the first group of transmission configuration indicator states, one or more messages on a physical downlink channel; and
transmit, to the base station using the second group of transmission configuration indicator states, one or more messages on a physical uplink channel.

20. The apparatus of claim 19, wherein the one or more processors are further configured to cause the apparatus to:
receive a message on the physical downlink channel using a first transmission configuration indicator state of the first group of transmission configuration indicator states; and
receive a repetition of the message on the physical downlink channel using a second transmission configuration indicator state of the first group of transmission configuration indicator states.

21-22. (canceled)

23. The apparatus of claim 19, wherein the one or more processors are further configured to cause the apparatus to:
transmit a message on the physical uplink channel using a first transmission configuration indicator state of the second group of transmission configuration indicator states; and
transmit a repetition of the message on the physical uplink channel using a second transmission configuration indicator state of the second group of transmission configuration indicator states.

24-25. (canceled)

26. The apparatus of claim 19, wherein the one or more processors are further configured to cause the apparatus to:
perform, based at least in part on receiving the downlink control information message, a beam sweep procedure using at least the first group of transmission configuration indicator states and the second group of transmission configuration indicator states.

27. The apparatus of claim 19, wherein the one or more processors are further configured to cause the apparatus to:
determine a first repetition mode for receiving the one or more messages on the physical downlink channel and a second repetition mode for transmitting the one or more messages on the physical uplink channel;
receive the one or more messages on the physical downlink channel according to the first repetition mode; and
transmit the one or more messages on the physical uplink channel according to the second repetition mode.

28-30. (canceled)

31. The apparatus of claim 19, wherein the one or more processors are further configured to cause the apparatus to:
determine that a second physical downlink channel does not support a repetition mode; and
receive, using a first transmission configuration indicator state of the first group of transmission configuration indicator states, one or more messages on the second physical downlink channel based at least in part on determining that the second downlink physical channel does not support the repetition mode.

32. The apparatus of claim 19, wherein the one or more processors are further configured to cause the apparatus to:
determine that a second physical uplink channel does not support a repetition mode; and
transmit, using a first transmission configuration indicator state of the second group of transmission configuration indicator states, one or more messages on the second physical uplink channel based at least in part on determining that the second physical uplink channel does not support the repetition mode.

33-34. (canceled)

35. The apparatus of claim 19, wherein the physical downlink channel is located on a single component carrier.

36. The apparatus of claim 19, wherein the physical downlink channel is located on multiple component carriers.

37-39. (canceled)

40. The apparatus of claim 19, wherein the downlink control information message comprises a downlink UE-specific downlink control information message, an uplink UE-specific downlink control information message, or a group common downlink control information message.

41. An apparatus for wireless communications at a base station, comprising:
one or more memories; and
one or more processor coupled with the one or more memories, the one or more processors configured to cause the apparatus to:
transmit, to a user equipment (UE), downlink control information comprising a joint beam indication, the joint beam indication comprising an indication of a group of transmission configuration indicator states associated with a reference signal;
communicate a message on a physical channel using a first transmission configuration indicator state of the group of transmission configuration indicator states; and
communicate a repetition of the message on the physical channel using a second transmission configuration indicator state of the group of transmission configuration indicator states.

42. The apparatus of claim 41, wherein the one or more processors are further configured to cause the apparatus to:
transmit a control message on a physical downlink control channel, transmit a data message on a physical downlink shared channel, or any combination thereof.

43. (canceled)

44. The apparatus of claim 41, wherein the message:
receive a control message on a physical uplink control channel, receive a data message on a physical uplink shared channel, or any combination thereof.

45. (canceled)

46. The apparatus of claim 41, wherein the one or more processors are further configured to cause the apparatus to:
perform, based at least in part on transmitting the downlink control information message, a beam sweep procedure using at least the first transmission configuration indicator state and the second transmission configuration indicator state.

47. The apparatus of claim 41, wherein the one or more processors are further configured to cause the apparatus to:
determine a repetition mode for communicating the message and the repetition of the message; and
communicate the message and the repetition of the message according to the repetition mode.

48-49. (canceled)

50. The apparatus of claim 41, wherein the one or more processors are further configured to cause the apparatus to:
determine that a second physical channel does not support a repetition mode; and
communicate a second message on the second physical channel using the first transmission configuration indicator state based at least in part on determining that the second physical channel that does not support the repetition mode.

51. The apparatus of claim 41, wherein the one or more processors are further configured to cause the apparatus to:
transmit, to the UE, a second downlink control information message activating the group of transmission configuration indicator states from a plurality of groups of transmission configuration indicator states, wherein communicating the message using the first transmission configuration indicator state and communicating the repetition of the message using the second transmission configuration indicator state are based at least in part on transmitting the second downlink control information message.

52. The apparatus of claim 41, wherein the one or more processors are further configured to cause the apparatus to:
transmit, to the UE, a second downlink control information message adding the group of transmission configuration indicator states to a plurality of groups of transmission configuration indicator states, or removing a second group of transmission configuration indicator states from the plurality of groups of transmission configuration indicator states, or any combination thereof, wherein communicating the message using the first transmission configuration indicator state and communicating the repetition of the message using the second transmission configuration indicator state are based at least in part on transmitting the second downlink control information message.

53-54. (canceled)

55. The apparatus of claim 41, wherein the one or more processors are further configured to cause the apparatus to:
transmit, to the UE, carrier aggregation configuration information for operating in a carrier aggregation mode.

56. (canceled)

57. An apparatus for wireless communications at a base station, comprising:
one or more memories; and
one or more processor coupled with the one or more memories, the one or more processors configured to cause the apparatus to:
transmit, to a user equipment (UE), a downlink control information message comprising at least one of a first beam indication and a second beam indication, the first beam indication comprising a first indication of a first group of transmission configuration indicator states associated with a first reference signal and the second beam indication comprising a second indication of a second group of transmission configuration indicator states associated with a second reference signal;
transmit, to the UE using the first group of transmission configuration indicator states, one or more messages on a physical downlink channel; and
receive, from the UE using the second group of transmission configuration indicator states, one or more messages on a physical uplink channel.

58. The apparatus of claim 57, wherein the one or more processors are further configured to cause the apparatus to:
transmit a message on the physical downlink channel using a first transmission configuration indicator state of the first group of transmission configuration indicator states; and
transmit a repetition of the message on the physical downlink channel using a second transmission configuration indicator state of the first group of transmission configuration indicator states.

59-60. (canceled)

61. The apparatus of claim 57, wherein the one or more processors are further configured to cause the apparatus to:
receive a message on the physical uplink channel using a first transmission configuration indicator state of the second group of transmission configuration indicator states; and
receive a repetition of the message on the physical uplink channel using a second transmission configuration indicator state of the second group of transmission configuration indicator states.

62. (canceled)

63. The apparatus of claim 57, wherein the one or more processors are further configured to cause the apparatus to:
perform, based at least in part on receiving the downlink control information message, a beam sweep procedure using at least the first group of transmission configuration indicator states and the second group of transmission configuration indicator states.

64-77. (canceled)

78. A method for wireless communication at a user equipment (UE), comprising:
receiving, from a base station, downlink control information comprising a joint beam indication, the joint beam indication comprising an indication of a group of transmission configuration indicator states associated with a reference signal;
communicating a message on a physical channel using a first transmission configuration indicator state of the group of transmission configuration indicator states; and
communicating a repetition of the message on the physical channel using a second transmission configuration indicator state of the group of transmission configuration indicator states.
